(19) United States
(12) Patent Application Publication
(10) Pub. No.: US 2026/0006026 A1
(43) Pub. Date: Jan. 1, 2026

(54) SYSTEMS AND METHODS FOR ENHANCED PEER-TO-PEER ASSET TRANSFERS

(71) Applicant: Wells Fargo Bank, N.A., San Francisco, CA (US)

(72) Inventors: Prafullata Diwate, San Francisco, CA (US); Elizabeth Mellers, San Francisco, CA (US)

(21) Appl. No.: 18/757,006

(22) Filed: Jun. 27, 2024

(51) Int. Cl. H04L 9/40

(52) U.S. Cl. CPC H04L 63/0853; H04L 63/083

(57) ABSTRACT

Systems, apparatuses, methods, and computer program products are disclosed for a secure peer-to-peer asset transfer. An example method includes receiving an asset transfer initiation request from a sender device, wherein the asset transfer initiation request comprises an indication of an asset to transfer and a sender account identifier associated with a sender account of a sender. The example method further includes receiving an indication of a recipient intended to receive the asset and selecting a recipient account associated with the recipient. The example method further includes authenticating the recipient based on a recipient mobile driver's license (mDL) associated with the recipient and in response to successfully authenticating the recipient, effectuating a transfer of the asset from the sender account to the recipient account.

### BACKGROUND

Peer-to-peer (P2P) transactions are a convenient way for individuals to settle obligations to other individuals. Current digital tools facilitating P2P transactions suffer from both real and perceived counterparty risks.

### BRIEF SUMMARY

Traditionally, a cash exchange has been used to facilitate P2P transactions. However, this approach offers no audit trail and presents many inconveniences, including requiring the individuals to carry cash and associated difficulties with finding with the correct denominations or an exchange. Furthermore, these cash-based P2P transactions have heightened associated risks, such as theft. While current digital tools facilitating P2P transfers avoid many of the issues associated with cash-based transactions, these tools also suffer from both real and perceived counterparty risk. This is particularly true for P2P exchanges that occur between strangers or even friends who have not previously engaged with a P2P exchange using the particular digital tool. Furthermore, individual users may use nicknames or other names that may make it difficult for the counterparty to accurately identify them within the digital tool.

In addition to payment transfers, users may wish to engage in other forms of P2P transfers, such as transfers of media, documents, and/or the like. While digital tools exist to facilitate these sorts of transfers, such tools currently lack enhanced security around verifying user identities. Additionally, such P2P transfers are not currently logged or tracked such that users cannot audit their transfers.

Therefore, it may be beneficial to provide a P2P transfer tool that enhances P2P transfers between users. For example, a sender may provide an asset transfer initiation request to an asset transfer management system, such as via a software application. The asset transfer initiation request may be indicative of an asset to transfer and a corresponding sender account identifier from which to transfer the asset. The sender device and the recipient device may communicate with one another to exchange a sender mobile driver's license (mDL) authentication request and a recipient mDL authentication request, respectively. The sender device may use the recipient mDL authentication request to verify the identity of the recipient. For example, the sender device may provide the asset transfer management system with the recipient mDL authentication request and the asset transfer management system may authenticate an associated recipient mDL with a corresponding issuing authority (IA) system. Similarly, the recipient device may provide the asset transfer management system with the sender mDL authentication request and the asset transfer management system may authenticate an associated sender mDL with a corresponding IA system. If both the recipient mDL and sender mDL are authenticated, the asset transfer management system may effectuate the asset transfer, resulting in the transfer of the asset from the sender account to an identified recipient account. The asset transfer management system may further log the details of the asset transfer in both the sender account and recipient account, such that the sender and recipient may view the details of the asset transfer and/or use these details for audit purposes.

In some embodiments, the sender device may authenticate the recipient. In particular, in some embodiments, the sender device may authenticate the associated recipient mDL with a corresponding IA system. Alternatively, in some embodiments, the sender device may authenticate the recipient based on user feedback. For example, the sender device may be configured to cause display of recipient information (e.g., recipient identification data, desired credential data, or user attribute data) associated with the recipient mDL. The sender device may then receive user feedback indicative of whether to authenticate the recipient and may authenticate the recipient based on this user feedback. The sender device may provide an authorization selection to the asset transfer management system and the asset transfer management system may authenticate the recipient based on this authorization selection. As such, embodiments described herein provide for a robust and flexible manner of authenticating the recipient that may be responsive to a variety of asset transfer circumstances. The manner of authentication of the recipient may be configured based on the type of asset indicated in the asset transfer, sender preferences regarding the method of authentication, and/or the like. In some embodiments, a combination of authentication procedures may be contemplated. For example, the recipient may be authenticated only in an instance in which the sender device and/or asset transfer management system successfully authenticates the associated recipient mDL with the corresponding IA system and the sender device receives user feedback indicative to authenticate the recipient.

In some embodiments, the recipient device may authenticate the sender. In particular, in some embodiments, the recipient device may authenticate the associated sender mDL with a corresponding IA system. Alternatively, in some embodiments, the recipient device may authenticate the sender based on user feedback. For example, the recipient device may be configured to cause display of recipient information (e.g., recipient identification data, desired credential data, or user attribute data) associated with the sender mDL. The recipient device may then receive user feedback indicative of whether to authenticate the sender and may authenticate the sender based on this user feedback. The recipient device may provide an authorization selection to the asset transfer management system and the asset transfer management system may authenticate the sender based on this authorization selection. As such, embodiments described herein also provide for a robust and flexible manner of authenticating the sender.

Additionally, in some embodiments, the asset transfer management system may select a recipient account associated with the recipient to receive the asset indicated in the asset transfer initiation request. In some embodiments, the asset transfer management system may use a set of selection rules to select the recipient account associated with a recipient user profile. The set of selection rules may include one or more selection rules that indicate mathematical and/or logical operations for selecting a recipient account. The set of selection rules may define the recipient account selection based on the number of recipient accounts, user preferences set within the recipient user profile, the type of asset indicated in the asset transfer initiation request, and/or the like. As such, the asset transfer management system may intelligently select a recipient account for the recipient with minimal to no required user intervention.

Furthermore, in some embodiments, the asset transfer management system may intelligently effectuate the transfer of the asset from the sender account to the recipient account. The method of transfer may be dependent upon user preferences in the recipient profile, the user preferences in the sender profile, the type of asset to be transferred, and/or the like. As such, the asset transfer management system may effectively and efficiently facilitate the transfer of the asset from the sender account to the recipient account.

Accordingly, the present disclosure sets forth systems, methods, and apparatuses that provide for enhanced P2P asset transfers.

There are many advantages of these and other embodiments described herein. For example, one advantage the asset transfer management system provides is an improvement to the functioning of the computing infrastructure of an enterprise (e.g., a bank or financial institution), such as by reducing the burden on computing resources. For instance, by facilitating authentication of both the sender and recipient prior to the asset transfer using associated mDLs, embodiments described herein significantly reduce the need for subsequent cancellations, returns, and/or other operations associated with when an asset transfer is made in error, which often require costly manual intervention and are computationally resource intensive. Thus, the system described herein reduces the complexity of P2P transfers by, among other things, automating processes, such as authenticating a sender based on a sender mDL and a recipient based on a recipient mDL, automatically selecting a recipient account for the recipient, automatically effectuating the transfer of the asset from the sender account to the recipient account in an intelligent manner, and updating user accounts of the sender and recipient to reflect the asset transfer for audit purposes.

Another advantage of the system, as described herein, is an improvement to network security technologies and/or authentication technologies by providing increased security for data, payment accounts, and/or valuable resources (e.g., financial resources) related to users (e.g., senders and recipients) and/or enterprises by utilizing mDLs associated with respective users to authenticate the respective users. In this regard, the asset transfer management system, sender device, and/or recipient device may be employed to remotely authenticate a recipient user and/or sender user based on a respective mDL. As will be described in greater detail below, utilizing mDLs that have been issued by legally entitled entities (e.g., government agencies) adds an additional layer of trust to each transaction facilitated by the asset transfer management system. Furthermore, utilizing mDLs to authenticate and/or verify a sender and recipient ensures that only intended parties are able to access the asset associated with an asset transfer initiation request.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for facilitating enhanced P2P asset transfers.

FIG. 2 illustrates a schematic block diagram of example circuitry embodying a system device that may perform various operations in accordance with some example embodiments described herein.

FIG. 3 illustrates a schematic block diagram of example circuitry embodying a sender device or recipient device that may perform various operations in accordance with some example embodiments described herein.

FIG. 4 illustrates an example flowchart diagram for effectuating an asset transfer between a sender and a recipient, in accordance with some example embodiments described herein.

FIG. 5 illustrates an example flowchart diagram for authenticating a recipient based on a recipient mDL authentication request, in accordance with some example embodiments described herein.

FIG. 6 illustrates an example flowchart diagram for authenticating a recipient based on an authorization selection, in accordance with some example embodiments described herein.

FIG. 7 illustrates an example flowchart diagram for authenticating a sender based on a sender mDL authentication request, in accordance with some example embodiments described herein.

FIG. 8 illustrates an example flowchart diagram for authenticating a sender based on an authorization selection, in accordance with some example embodiments described herein.

FIG. 9 illustrates an example flowchart diagram for providing candidate recipient identifiers, in accordance with some example embodiments described herein.

FIG. 10 illustrates an example flowchart diagram for facilitating an asset transfer to a recipient using a sender device, in accordance with some example embodiments described herein.

FIG. 11 illustrates an example flowchart diagram for authenticating a recipient using a sender device, in accordance with some example embodiments described herein.

FIG. 12 illustrates an example flowchart diagram for authenticating a recipient based on user feedback, in accordance with some example embodiments described herein.

FIG. 13 illustrates an example flowchart diagram for facilitating an asset transfer from a sender device using a recipient device, in accordance with some example embodiments described herein.

FIG. 14 illustrates an example flowchart diagram for authenticating a sender using a recipient device, in accordance with some example embodiments described herein.

FIG. 15 illustrates an example flowchart diagram for authenticating a sender based on user feedback, in accordance with some example embodiments described herein.

FIG. 16 illustrates an example user interface associated with an asset transfer tool for performing an asset transfer, in accordance with some example embodiments described herein.

FIG. 17 illustrates an example user interface associated with an asset transfer tool for sharing a mDL with another user, in accordance with some example embodiments described herein.

FIG. 18 illustrates an example user interface associated with an asset transfer tool for soliciting user feedback for authentication, in accordance with some example embodiments described herein.

FIGS. 19A-19B illustrate swim lane diagrams with example operations for an example embodiment that may be performed by components of the environment depicted in FIG. 1, in accordance with some example embodiments described herein.

FIGS. 20A-20B illustrate swim lane diagrams with example operations for another example embodiment that may be performed by components of the environment depicted in FIG. 1, in accordance with some example embodiments described herein.

FIGS. 21A-21B illustrate swim lane diagrams with example operations for another example embodiment that may be performed by components of the environment depicted in FIG. 1, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “user device” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server,” “server device,” or “server system” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

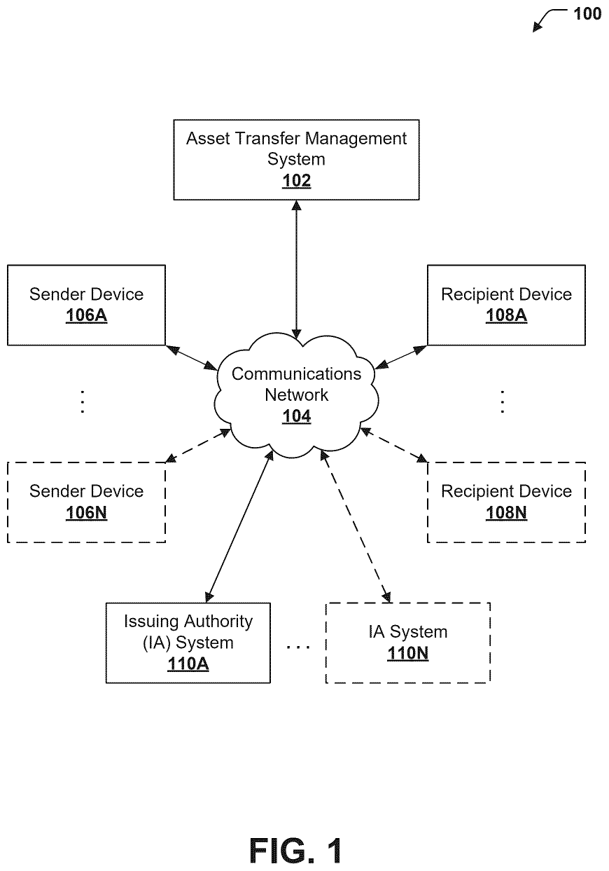

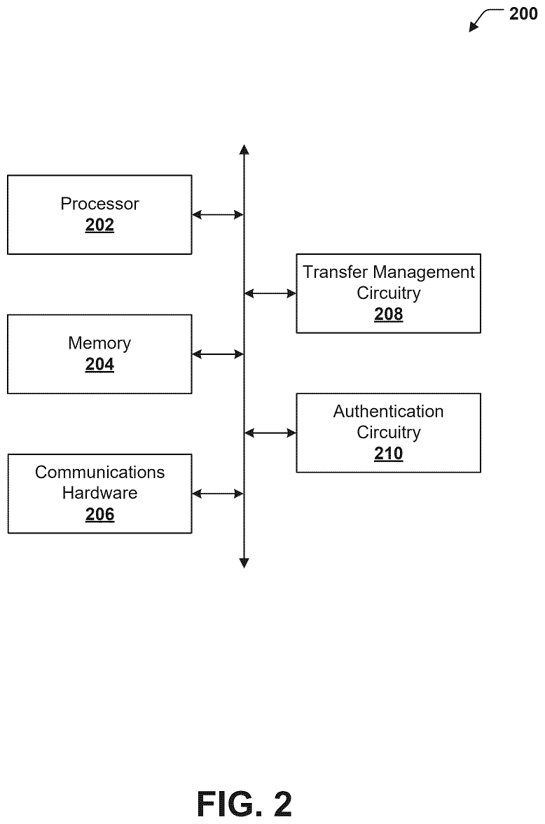

Example embodiments described herein may be implemented using any of a variety of computing devices or servers. To this end, FIG. 1 illustrates an example environment 100 within which various embodiments may operate. As illustrated, an asset transfer management system 102 may receive and/or transmit information via communications network 104 (e.g., the Internet) with any number of other computing devices and/or computing systems, such as one or more of sender devices 106A-106N, recipient devices 108A-108N, and/or issuing authority (IA) systems 110A-110N. The asset transfer management system 102 may be implemented as one or more computing devices or servers, which may be composed of a series of components. Particular components of the asset transfer management system 102 are described in greater detail below with reference to apparatus 200 in connection with FIG. 2.

In various embodiments, the asset transfer management system 102 may be associated with an enterprise (e.g., a financial institution, bank, and/or the like) and may be configured to manage the transfer of assets between user accounts. In some embodiments, the asset transfer management system 102 may further be configured to manage various smart mobile wallet processes for users associated with said enterprise. For example, the asset transfer management system 102 may be configured to manage, execute, initiate, and/or otherwise facilitate one or more smart mobile wallet processes, mDL authentication processes, transaction processes, payment account linking processes, payment account transaction processes, user identity verification process, user authentication processes, and/or the like for a plurality of users associated with the respective enterprise.

In this regard, various users associated with an enterprise may interact with the asset transfer management system 102 via a software application instance, where the software application instance may be configured to facilitate one or more of the various smart mobile wallet, mDL authentication processes, and/or asset transfer processes described herein. In various embodiments, the software application instance associated with the asset transfer management system 102 may be installed and/or downloaded to a user device (e.g., a sender device 106A or a recipient device 108A configured as a mobile device, laptop, and/or the like) and may present one or more user interface configurations to a respective user (e.g., a sender or recipient). In some embodiments, the software application instance is a mobile application.

As such, the software application instance associated with the asset transfer management system 102 may be configured to guide a user (e.g., a sender or recipient) through the various steps of an asset transfer process, or other processes, such as a mobile deposit process, a disbursement payment claim process, a payment account linking process, and/or the like that may require a user to be authenticated based on a corresponding mDL. For example, the software application instance associated with the asset transfer management system 102 may be configured to cause display of various interactive user interface elements to the user that are configured to enable the user to manage one or more portions of smart mobile wallet data (e.g., payment account data, payment card data, and/or the like) and/or user data (e.g., user attribute data, user profile data, user account data, and/or other user data).

In some embodiments, the software application instance may be configured to enable a user (e.g., a sender or recipient) to access a smart mobile wallet (e.g., a digital wallet) configured to manage one or more of a user's mDL, user accounts (e.g., credit accounts, checking accounts, savings accounts, investment accounts, email accounts), and/or payment cards (e.g., credit cards, debit cards, and/or the like associated with the user's payment accounts) that are associated with a respective enterprise employing the asset transfer management system 102. Additionally or alternatively, in various embodiments, the software application instance associated with the asset transfer management system 102 may be configured to enable a user to access a software application framework related to a respective enterprise by, for example, providing (e.g., transmitting, enabling, toggling, configuring) one or more access permissions for a user device (e.g., any one of sender devices 106A-106N and/or recipient devices 108A-108N) associated with the user (e.g., a sender or a recipient), where the one or more access permissions enable the user device to access the software application framework associated with the enterprise.

As described herein, the asset transfer management system 102 may be configured to facilitate the transfer of an asset between a sender and a recipient. For example, an asset may be funds, a financial instrument, media (e.g., pictures, videos), documents, and/or the like that may belong to a sender. As such, the asset transfer management system 102 may be configured to integrate and/or communicate with one or more computing systems associated with an affiliated enterprise (e.g., a financial institution, banking institution, and/or the like) and/or one or more clearinghouses authorized to settle financial transactions (e.g., purchases, money transfers) between various merchants and the enterprise on behalf of one or more users. For example, the asset transfer management system 102 may be configured to cause an appropriate amount of funds (e.g., the asset) to be withdrawn from one or more payment accounts associated with the sender based on any legitimate transaction executed utilizing a payment method (e.g., payment card, digital payment card, account number, routing number, and/or the like) associated with the one or more payment accounts.

In some embodiments, the asset transfer management system 102 may be configured to facilitate the execution of one or more processes related to the asset transfer for a respective sender and/or recipient based on authenticating an mDL associated with the recipient and/or sender. As a non-limiting example, the asset transfer management system 102 may be configured to authenticate a recipient based on a respective mDL associated with the recipient before effectuating the asset transfer on behalf of the sender. In this regard, the asset transfer management system 102 may be configured to store, integrate with, manage, and/or utilize one or more mDLs (and/or data related to the one or more mDLs (e.g., mDL identifying information, cryptographic key information)) associated with a respective user in order to facilitate the various operations described herein. In some embodiments, a sender device (e.g., any one of sender devices 106A-106N) may be configured to authenticate a recipient based on a respective recipient mDL associated with the recipient. In some embodiments, a recipient device (e.g., any one of recipient devices 108A-108N) may be configured to authenticate a sender based on a respective sender mDL associated with the sender. As such, in some embodiments, a recipient device and/or sender device may be configured to store, integrate with, manage, and/or utilize one or more mDLs (and/or data related to the one or more mDLs (e.g., mDL identifying information, cryptographic key information)) associated with a respective user in order to facilitate the various operations described herein.

As used herein, the term “mDL” covers various mobile (e.g., digital) identity credential types associated with a respective user including mobile driver's licenses and mobile identification cards. An mDL may be an electronically managed data structure configured to be accessed, processed, and/or otherwise utilized by the asset transfer management system 102 for various user authentication processes. In this regard, an mDL may be configured to store or point to (e.g., programmatically reference) various credential data associated with a respective user including, but not limited to, personally identifiable information (PII) (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating IA data (e.g., cryptographic key information and/or identifying data associated with an originating IA).

An mDL may be issued (e.g., provisioned) to a respective user by an IA system 110A associated with a particular IA. An IA may be an entity that is legally entitled (or otherwise recognized as the relevant authority) to issue credentials, such as driver's licenses and/or other identification cards. An IA system 110A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 110A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally or alternatively, in some embodiments, an mDL may be administered, managed, employed, and/or otherwise utilized by the asset transfer management system 102 in compliance with various standards set forth by the American Association of Motor Vehicle Administrators (AAMVA). Additionally or alternatively, in some embodiments, an mDL may be administered, managed, employed, and/or otherwise utilized by the asset transfer management system 102 in compliance with various standards set forth by the International Organization for Standardization (ISO) and the International Electrotechnical Commission (IEC) (e.g., ISO/IEC 18013-5). It will be understood that other standards may apply in some implementations.

An mDL may be a digital version of a physical legal credential (e.g., a driver's license) associated with a user and may comprise and/or be associated with the same data as the legal credential. In some embodiments, an mDL associated with a user may be stored in a storage device (e.g., a server system) of an IA system 110A and one or more portions of credential data related to the mDL may be retrieved in real time, or near-real time, during a transaction associated with the user (e.g., an online transaction requiring user authentication, user age verification, and/or the like). Additionally, or alternatively, once an mDL is issued to a user by a respective IA (e.g., by way of a corresponding IA system 110A), the mDL may be stored locally on a user device associated with the user (e.g., any one of sender devices 106A-106N for a sender or any one of recipient devices 108A-108N for a recipient) such that the mDL may be used without relying on a communications network (e.g., communications network 104). Additionally, or alternatively, in some embodiments, an mDL may be stored in a smart mobile wallet associated with the user and managed by the asset transfer management system 102, and the mDL may be accessed and/or utilized by the user via the smart mobile wallet to execute various mDL-based transactions.

In some examples, an IA may provision an mDL to a particular user device (e.g., any one of sender devices 106A-106N for a sender or any one of recipient devices 108A-108N for a recipient) associated with a user such that the mDL is associated with various user device identification data related to the particular user device (e.g., cryptographical identification data, such as a public key). This may ensure that an mDL associated with a respective user cannot be transferred to multiple devices without authorization by the IA system (e.g., IA system 110A) and used in fraudulent transactions. Furthermore, associating an mDL with a particular user device (e.g., a sender device 106A-106N for a sender or a recipient device 108A-108N for a recipient) also enables the asset transfer management system 102 and/or an IA system of an IA (e.g., IA system 110A) to verify that the intended user of the mDL is in possession of the mDL. Further still, associating an mDL with a particular user device also ensures the safe transfer of sensitive credential data to and/or from the intended user of the mDL. In various examples, a user may store multiple copies of an mDL on multiple user devices (e.g., user devices 108A-108N). However, in such examples, each respective copy of the mDL may be cryptographically coupled to a respective user device by the IA system (e.g., IA system 110A) that provisioned the mDL. In this manner, each copy of the mDL can be independently verified against a respective user device to ensure that the mDL, or credential data associated with the mDL, cannot be transferred to unauthorized user devices.

An mDL may be associated with various mDL data security mechanisms used to ensure the validity of the mDL, authenticate an originating IA that issued the mDL, protect a user's personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding user may not be permitted to engage in one or more transactions using the mDL (e.g., one or more age-restricted purchase transactions).

Additionally, an mDL may be associated with various cryptographic key information (e.g., public/private key pair information) that may be utilized by the asset transfer management system 102 to authenticate an originating IA that issued the mDL, verify one or more portions of credential data associated with an mDL, and/or facilitate various mDL-based transactions (e.g., asset transfer operations, retail purchase transactions, user authentication protocols, mDL data queries) for a user associated with the mDL. For example, an IA associated with a respective IA system 110A may be associated with a unique public key that may be utilized by the asset transfer management system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a user by the asset transfer management system 102 will be described in greater detail herein with reference to FIGS. 2-15.

In some embodiments, the asset transfer management system 102 further comprises and/or integrates with a storage device that comprises a distinct component from other components of the asset transfer management system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally, or alternatively, the storage device may host the software executed to operate the asset transfer management system 102. Additionally or alternatively, the storage device may store information relied upon during operation of the asset transfer management system 102, such as various user data (e.g., user attribute data, user identification data), mDL data (e.g., cryptographical information, credential information), enterprise data (e.g., payment account data, user transaction data, product and/or service data), smart mobile wallet data (e.g., payment account data, payment card data, asset data, and/or the like associated with a user), distribution data, logistical data, legal data, software application framework data, etc.), and/or the like configured in various data formats to be utilized by the asset transfer management system 102. In addition, the storage device may store control signals, device characteristics, and/or access credentials enabling interaction between the asset transfer management system 102 and/or one or more of the enterprise computing devices 106A-106N or user devices 108A-108N.

In various embodiments, the one or more sender devices 106A-106N and/or the one or more recipient devices 108A-108N may be embodied by any computing devices known in the art. The one or more sender devices 106A-106N and/or the one or more recipient devices 108A-108N need not themselves be independent devices but may be peripheral devices communicatively coupled to other computing devices. In some embodiments, the one or more sender devices 106A-106N may be associated with a particular sender. In some embodiments, the one or more recipient devices 108A-108N may be associated with a particular recipient.

### Example Implementing Apparatuses

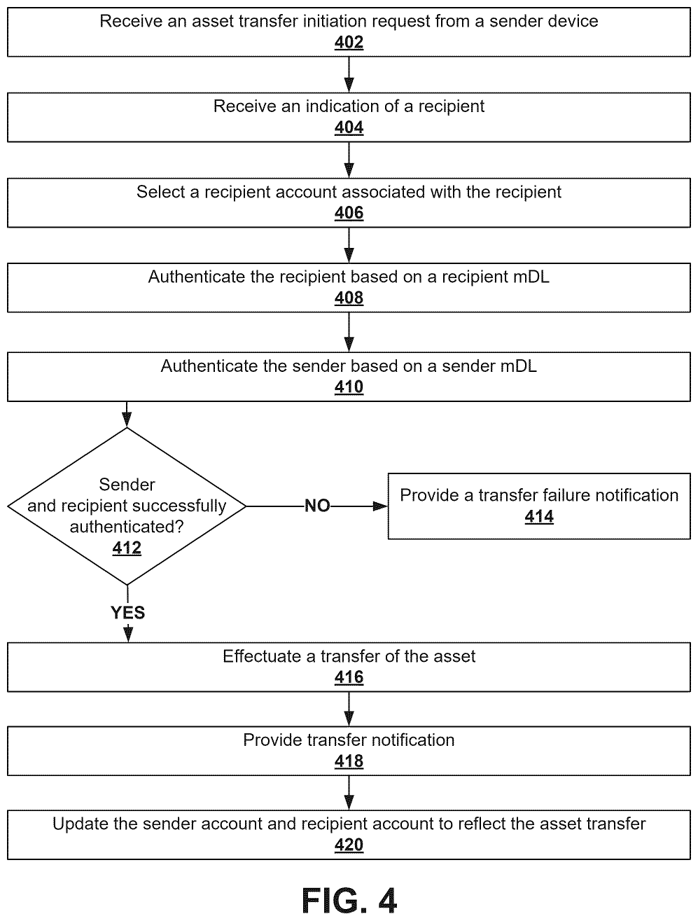

The asset transfer management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-21B. As illustrated in FIG. 2, the apparatus 200 may include processor 202, memory 204, communications hardware 206, transfer management circuitry 208, and/or authentication circuitry 210, each of which will be described in greater detail below.

The processor 202 (and/or coprocessor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance (e.g., a mobile application), dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises transfer management circuitry 208. In some embodiments, the transfer management circuitry 208 may be configured to select a recipient account associated with a recipient, effectuate the transfer of an asset, and update the sender account and recipient account to reflect the asset transfer. Additionally, the transfer management circuitry 208 may utilize processor 202, memory 204, or any other hardware component included in the apparatus 200 to perform these operations, as described in connection with FIGS. 4-9 below. The transfer management circuitry 208 may further utilize the communications hardware 206 to gather data from, or transmit data to, a variety of sources (e.g., the sender devices 106A-106N, recipient devices 108A-108N, the IA systems 110A-110N, and/or any storage devices associated with the asset transfer management system 102), and/or exchange data with a user. In some embodiments, the transfer management circuitry 208 may work in conjunction with the authentication circuitry 210 in order to execute one or more of the methods described herein.

In addition, the apparatus 200 further comprises authentication circuitry 210. In some embodiments, the authentication circuitry 210 may be configured to authenticate the recipient based on a recipient mDL and/or authenticate the sender based on a sender mDL. Additionally, the authentication circuitry 210 may utilize processor 202, memory 204, or any other hardware component included in the apparatus 200 to perform these operations, as described in connection with FIGS. 4-9 below. The authentication circuitry 210 may further utilize the communications hardware 206 to gather data from, or transmit data to, a variety of sources (e.g., the sender devices 106A-106N, recipient devices 108A-108N, the IA systems 110A-110N, and/or any storage devices associated with the asset transfer management system 102), and/or exchange data with a user. In some embodiments, the authentication circuitry 210 may work in conjunction with the transfer management circuitry 208 in order to execute one or more of the methods described herein.

In various circumstances, an IA system (e.g., IA system 110A) that previously issued an mDL to a respective user may periodically update credential data associated with the mDL (e.g., new user contact information, updated credential restrictions, updated credential endorsements). As such, the authentication circuitry 210 may be configured to retrieve and/or receive updated credential data associated with a user's mDL from an IA system (e.g., IA system 110A) and facilitate the updating of the user's mDL based on the updated credential data. For example, if an mDL associated with a user (e.g., sender or recipient) is stored in a smart mobile wallet being managed by the asset transfer management system 102, the authentication circuitry 210 may be configured to receive updated credential data associated with the user's mDL from the originating IA system (e.g., IA system 110A) and subsequently update the user's mDL in the smart mobile wallet based on the updated credential data.

In some embodiments, the authentication circuitry 210 may update an mDL stored in a smart mobile wallet stored on a user device (e.g., any one of sender devices 106A-106N and/or recipient devices 108A-108N). In such embodiments, the authentication circuitry 210 may be configured to query one or more storage devices (e.g., server systems) associated with an IA system (e.g., IA system 110A) in order to retrieve current and/or updated credential data in response to one or more interactions with a user interface associated with the smart mobile wallet. Additionally, or alternatively, the authentication circuitry 210 may be configured to periodically query to one or more storage devices (e.g., server systems) associated with an IA system (e.g., IA system 110A) based on a predefined schedule (e.g., once a day, once a week, once a month, once every 90 days) in order to retrieve current and/or updated credential data associated with a user's mDL.

In various examples, an IA (e.g., a branch of the DMV) associated with a respective IA system (e.g., IA system 110A) may enforce various mDL data freshness requirements associated with the mDLs the IA system provisions to users. In this regard, an MSO associated with a respective mDL may indicate a technical validity period associated with the mDL (e.g., a 30-day validity period). As such, the authentication circuitry 210 may utilize the technical validity period indicated by the MSO to ensure that the credential data associated with the mDL stored on a user device (e.g., any one of sender devices 106A-106N and/or recipient devices 108A-108N) is updated and/or current. For example, if the authentication circuitry 210 determines that the technical validity period indicated by the MSO has expired, the mDL may be invalidated until the credential data associated with the mDL is refreshed (e.g., updated, verified) by the IA system 110A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver's license associated with the mDL).

For example, legal credentials (e.g., a driver's license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular user's legal credential, yet the user fails to have the legal credential (e.g., a corresponding physical credential) updated with said credential restrictions and/or credential endorsements. To address such problems, if the authentication circuitry 210 determines that the technical validity period indicated by the MSO of the mDL has expired, the corresponding authentication circuitry 210 may flag the mDL such that the mDL will fail various authentication protocols during an mDL-based asset transfer.

In this regard, the authentication circuitry 210 may be configured to facilitate the resetting of the technical validity period indicated by the MSO of the mDL in conjunction with a corresponding IA system (e.g., IA system 110A). Additionally, or alternatively, the authentication circuitry 210 may be configured to facilitate the updating and/or verification of the credential data associated with an mDL stored on a user device (e.g., any one of sender devices 106A-106N and/or recipient devices 108A-108N) each time the technical validity period associated with the MSO of the mDL is reset. This mDL data security mechanism ensures that the credential data associated with a user's mDL is always accurate and up to date.

As described herein, an mDL may be associated with various cryptographic key information (e.g., public/private key pair information) that may be utilized by the asset transfer management system 102 to authenticate an originating IA that issued the mDL, verify one or more portions of credential data associated with an mDL, and/or facilitate various mDL-based asset transfers for a user (e.g., a sender or recipient) associated with the mDL. In this regard, the authentication circuitry 210 may be configured to generate and/or transmit an IA authentication request comprising a public key associated with an IA to a corresponding IA system 110A in order to verify that a particular mDL was indeed provisioned by the IA associated with the IA system 110A.

In some examples, an mDL may only comprise (e.g., store, point to) identifying information related to a particular IA such that the authentication circuitry 210 may be configured to first obtain a public key associated with the IA from a corresponding IA system 110A based on the identifying information. Once the public key information associated with the IA is obtained, the authentication circuitry 210 may be configured to generate an IA authentication request comprising the public key of the IA and transmit the IA authentication request to the IA system 110A (e.g., via the communications network 104). As such, the authentication circuitry 210 may be configured to receive, from an IA system (e.g., IA system 110A) and in response to the IA authentication request, one or more portions of data indicating whether the IA is a bona fide IA and/or whether the mDL indeed originated from the IA.

Once the authentication circuitry 210 confirms the validity of the IA and/or confirms that a particular mDL associated with a user originated from the IA, the authentication circuitry 210 may be configured to generate a digital token comprising cryptographical information (e.g., public key information) associated with the mDL and the user. Additionally, in some embodiments, the cryptographical information associated with the mDL and comprised in the digital token may be user device identification data by which a user device (e.g., any one of sender device 106A-106N and/or recipient devices 108A-108N) of the respective user may be uniquely identified. In various examples, the authentication circuitry 210 may generate and/or transmit the digital token to an IA system (e.g., IA system 110A) such that the IA system may decrypt the cryptographical information comprised in the digital token. In this manner, the IA system (e.g., IA system 110A) may authenticate (e.g., verify) one or more portions of credential data associated with the mDL and/or one or more portions of user device identification data associated with the user device (e.g., any one of sender device 106A-106N and/or recipient devices 108A-108N). In this regard, the authentication circuitry 210 may be configured to receive, from the IA system (e.g., IA system 110A) and in response to transmitting the digital token, one or more portions of data indicating whether the mDL and/or the user device (e.g., any one of sender device 106A-106N and/or recipient devices 108A-108N) identified by the digital token is valid. Furthermore, in various examples, the authentication circuitry 210 may be configured to receive, from the IA system (e.g., IA system 110A) and in response to transmitting the digital token, one or more portions of credential data associated with the mDL.

In some embodiments, the authentication circuitry 210 may be configured to generate a digital token comprising cryptographical information (e.g., public key information) associated with an mDL and/or a user device (e.g., any one of sender device 106A-106N and/or recipient devices 108A-108N) associated with a particular user in response to an mDL authentication request associated with the particular user. In some embodiments, the mDL authentication request may be a request to authenticate an mDL associated with the particular user and thereby authenticate the identity of the particular user for one or more mDL-based transactions. A respective mDL authentication request may comprise one or more of cryptographical information (e.g., public key information) associated with an mDL and/or a user device (e.g., any one of sender device 106A-106N and/or recipient devices 108A-108N). Additionally or alternatively, a respective mDL authentication request may comprise one or more desired data elements (e.g., one or more desired portions of credential data) associated with the mDL, location data, user profile data, user account data, social media data, smart mobile wallet identification data, user device identification data, and/or the like associated with the particular user.

In various examples, an mDL validity response received from an IA system (e.g., IA system 110A) based on a digital token generated by the authentication circuitry 210 may comprise the entirety of the credential data associated with the mDL of the particular user. Additionally, or alternatively, in various other examples, an mDL validity response received from an IA system (e.g., IA system 110A) based on a digital token generated by the authentication circuitry 210 may comprise a verification of the desired credential data associated with the mDL that was indicated by an mDL authentication request. Additionally, or alternatively, in various other examples, an mDL validity response received from an IA system (e.g., IA system 110A) based on a digital token generated by the authentication circuitry 210 may comprise a verification of the user device identification data associated with the user device (e.g., any one of sender device 106A-106N and/or recipient devices 108A-108N) of the particular user. For example, the mDL validity response may verify that the user device currently associated with the mDL is the same (e.g., intended) user device that the mDL was originally provisioned to. In this manner, the asset transfer management system 102 may be configured to confirm the validity of the mDL data of an mDL associated with a particular user in order to authenticate the identity of the particular user. Additionally, this enables the asset transfer management system 102 to confirm whether the intended user and/or user device (e.g., any one of sender device 106A-106N and/or recipient devices 108A-108N) associated with the mDL is currently in possession of the mDL. These and other operations associated with the authentication circuitry 210 will be described in further detail herein below with reference to FIGS. 4-9.

Additionally, in some embodiments, the authentication circuitry 210 may be configured to identify a smart mobile wallet associated with a respective user (e.g., a sender, recipient, and/or the like). In some embodiments, user attribute data associated with a respective user (e.g., a recipient, a sender, and/or the like) may comprise user profile data, user account data, user contact data, social media data, location data, and/or smart mobile wallet identification data associated with the respective user. In various examples, the user identification data associated with a respective user (e.g., the primary user, the designated user, and/or the like) comprises cryptographical information associated with one or more of an mDL and/or a user device (e.g., any one of sender device 106A-106N and/or recipient devices 108A-108N) associated with the respective user. In some embodiments the cryptographical information associated with the mDL and/or the user device may be a public key of a public/private key pair, where the public key is provisioned to the respective user by an IA upon issuance of the mDL. Such cryptographical information may be utilized by the asset transfer management system 102 and/or an IA system (e.g., IA system 110A) associated with the IA that provisioned the mDL to identify and/or authenticate the mDL, one or more portions of desired mDL credential data, and/or the user device associated with the respective user. In this regard, the authentication circuitry 210 may be configured to verify that the smart wallet ostensibly associated with the respective user (e.g., the primary user, the designated user, and/or the like) is indeed associated with the respective user and that the transfer management circuitry 208 may safely transmit and/or receive assets to and/or from the smart mobile wallet associated with the respective user.

Although components 202-210 are described in part using functional language, it will be understood that the particular implementations necessarily include the use of particular hardware. It should also be understood that certain of these components 202-210 may include similar or common hardware. For example, the transfer management circuitry 208 and/or the authentication circuitry 210 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the transfer management circuitry 208 and/or the authentication circuitry 210 may leverage processor 202, memory 204, and/or communications hardware 206 as described above, it will be understood that any of the transfer management circuitry 208 and/or the authentication circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the transfer management circuitry 208 and/or the authentication circuitry 210 comprise particular machinery designed for performing the functions described herein in connection with such elements of apparatus 200.

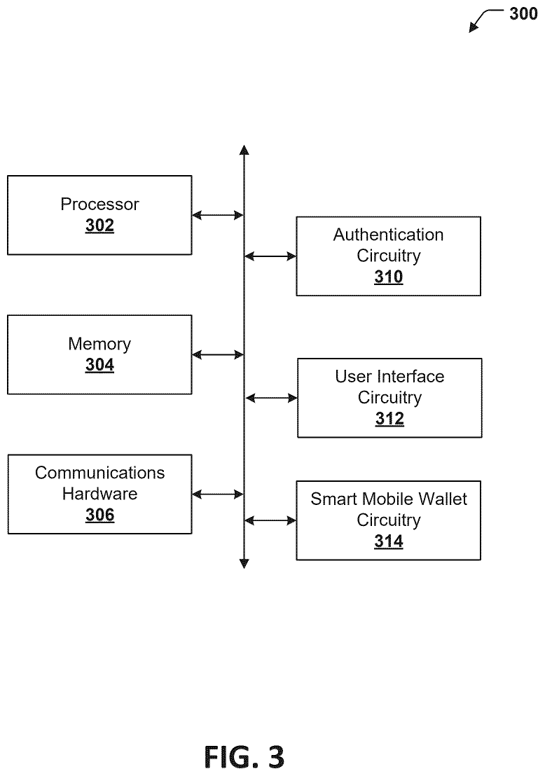

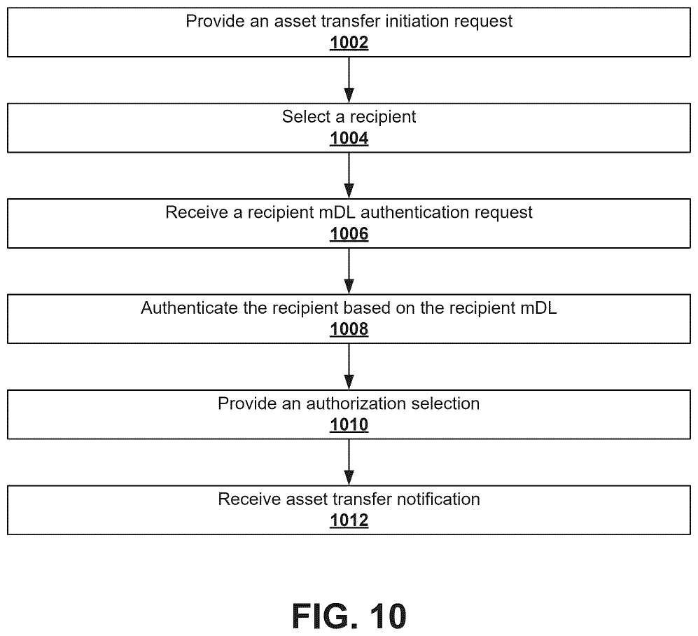

As illustrated in FIG. 3, an apparatus 300 is shown that represents an example sender device (e.g., any one of sender devices 106A-106N) or an example recipient device (e.g., any of recipient devices 108A-108N). The apparatus 300 includes processor 302, memory 304, communications hardware 306, and authentication circuitry 310, each of which is configured to be similar to the similarly named components described above in connection with FIG. 2. Additionally, the apparatus 300 may also include smart mobile wallet circuitry 314, and/or user interface circuitry 312, each of which may be configured to facilitate the execution of the various methods described herein. For example, the smart mobile wallet circuitry 314, and/or the user interface circuitry 312 may be configured to work in conjunction to facilitate user interaction with the asset transfer management system 102. Furthermore, the smart mobile wallet circuitry 314 may be configured to manage and/or facilitate one or more actions related to a smart mobile wallet associated with a respective user (e.g., a recipient, a sender and/or the like) on a user device (e.g., any one of a sender device 106A-106N and/or a recipient device 108A-108N) that has been provisioned by the asset transfer management system 102. In some embodiments, the smart mobile wallet circuitry 314 may utilize processor 302, memory 304, or any other hardware component included in the apparatus 300 to perform one or more of the operations described in connection with FIGS. 10-15 below.

In some embodiments, the smart mobile wallet circuitry 314 includes hardware components designed for generating one or more requests configured to initiate various operations to be executed by the asset transfer management system 102. For example, the smart mobile wallet circuitry 314 may be configured to generate an asset transfer initiation request (e.g., user input, user selection) with a smart mobile wallet on a user device (e.g., any one of a sender device 106A-106N and/or a recipient device 108A-108N). In some embodiments, parameters associated with the asset transfer initiation request may be entered, selected, and/or otherwise indicated in whole or in part by the associated user (e.g., via a user interface associated with a smart mobile wallet). Additionally, or alternatively, the parameters associated with the asset transfer initiation request may be automatically populated in whole or in part by the smart mobile wallet circuitry 314.

In various embodiments, the smart mobile wallet circuitry 314 may be configured to generate responses to various queries transmitted to a smart mobile wallet on a respective user device (e.g., any one of a sender device 106A-106N and/or a recipient device 108A-108N). For example, as described herein, the asset transfer management system 102 may be configured to generate and/or transmit authentication requests and/or user identification data requests to respective smart mobile wallets to facilitate the one or more operations described herein. As such, the smart mobile wallet circuitry 314 may be configured to generate and/or cause transmission of a response providing a mDL authentication request and/or user identification data comprised in and/or associated with a smart mobile wallet on the user device (e.g., any one of a sender device 106A-106N and/or a recipient device 108A-108N).

As described herein, the user identification data associated with a respective user (e.g., the primary user, the designated user, and/or the like) may comprise cryptographical information associated with one or more of an mDL and/or a user device (e.g., any one of a sender device 106A-106N and/or a recipient device 108A-108N) associated with the respective user. In some embodiments the cryptographical information associated with the mDL and/or the user device may be a public key of a public/private key pair, where the public key is provisioned to the respective user by an IA upon issuance of the mDL. Such cryptographical information may be utilized by the asset transfer management system 102, apparatus 300, and/or an IA system (e.g., IA system 110A) associated with the IA that provisioned the mDL to identify and/or authenticate the mDL, one or more portions of desired mDL credential data, and/or the user device associated with the respective user.

Furthermore, the smart mobile wallet circuitry 314 may be configured to facilitate various actions associated with an mDL of a respective user that is stored in and/or associated with the smart mobile wallet on a respective user device (e.g., any one of sender devices 106A-106N and/or a recipient devices 108A-108N). For example, the smart mobile wallet circuitry 314 may be configured to cause an mDL to be updated, verified, authenticated, and/or deleted from the smart mobile wallet. In some embodiments, the smart mobile wallet circuitry 314 may be configured to leverage the communications hardware 306 to communicate with an IA system (e.g., IA system 110A) in order to retrieve and/or receive one or more portions of mDL data (e.g., updated credential data) associated with an mDL stored in the smart mobile wallet. Additionally, or alternatively, the smart mobile wallet circuitry 314 may be configured to leverage the communications hardware 306 to cause one or more components of the apparatus 300 (e.g., the authentication circuitry 310) to facilitate the update of an mDL stored in a smart mobile wallet of a respective user device (e.g., any one of sender devices 106A-106N and/or a recipient devices 108A-108N).

In addition, the apparatus 300 may also include the user interface circuitry 312, which includes hardware components designed for receiving user inputs and/or rendering virtual graphics outputs. The user interface circuitry 312 may utilize processor 302, memory 304, or any other hardware component included in, or integrated with, the apparatus 300 to perform these operations, as described in connection with FIGS. 10-15 below. The user interface circuitry 312 may further utilize communications hardware 306 to transmit data representative of a user input and/or receive data to render as a virtual graphics output or may otherwise utilize processor 302 and/or memory 304 to generate data representative of a user input and/or generate virtual graphics output, e.g., from based on received data. The user interface circuitry 312 may comprise one or more of a keyboard, pointing device, touchscreen, microphone with speech recognition interface, one or more cameras, and/or one or more other input devices capable of receiving various different user inputs. In addition, the user interface circuitry 312 may comprise a display device including one or more of a screen with graphical user interface (GUI), speaker, light-emitting diode (LED) display, organic LED (OLED) display, LCD display, touchscreen, haptic technology device, and/or other output device capable of rendering information to a user.

Additionally, the user interface circuitry 312 may utilize processor 302, memory 304, smart mobile wallet circuitry 314, or any other hardware component included in, or integrated with, the apparatus 300 to run, host, configure, and/or otherwise execute one or more operations, instructions, and/or commands related to a software application instance and/or smart mobile wallet associated with the asset transfer management system 102. For example, the user interface circuitry 312 may be configured allow a user to interact with the asset transfer management system 102 via the software application instance in order to facilitate one or more asset transfer operations, smart mobile wallet operations, authentication operations, and/or any of the other methods described herein.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Asset Transfer Management System Example Operations

Turning first to FIGS. 4-9, example flowcharts are illustrated that contain example operations implemented by example embodiments described herein. The operations illustrated in FIGS. 4-9 may, for example, be performed by a system device (e.g., server, etc.) of the asset transfer management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, transfer management circuitry 208, authentication circuitry 210, and/or any combination thereof. It will be understood that user interaction with the asset transfer management system 102 may occur directly via communications hardware 206, or may instead be facilitated by a separate computing device (e.g., any of sender devices 106A-106N and/or recipient devices 108A-108N shown in FIG. 1, which may in turn be embodied by an apparatus 300, which is shown and described in connection with FIG. 3), and which may have similar or equivalent physical componentry facilitating such user interaction.

Turning first to FIG. 4, the flowchart illustrates example operations for facilitating an asset transfer between a sender and a recipient. As shown by operation 402, the apparatus 200 may include means, such as processor 202, memory 204, communications hardware 206, and/or the like for receiving an asset transfer initiation request from a sender device. The asset transfer initiation request may include an indication of an asset to transfer. An asset may include any item, resource, or the like that belongs to the sender, either wholly or in part. For example, an asset may be monetary funds, a financial instrument, media (e.g., pictures, videos, etc.), documents, information, data and/or the like. In some embodiments, an asset may have an economic value. For example, an asset of monetary funds may be valued at the amount of funds, such as $30. In some embodiments, the asset need not have an express or tangible economic value. For example, documents, media, information, data, etc. may not have a tangible economic value.

The asset transfer initiation request may further include a sender account identifier associated with a sender account of the sender. In some embodiments, the sender account identifier may be a unique combination of numbers, letters, or a combination thereof that uniquely identifies the sender account from other user accounts, including other sender accounts. In some embodiments, the sender account may be associated with a payment account (e.g., credit account, checking account, savings account, investment account). The sender account may also be associated with a sender identifier. The sender identifier may be a unique combination of numbers, letters, or a combination thereof that uniquely identifies the sender from other users. In some embodiments, the sender identifier is associated with a sender's user profile. A user profile may be associated with one or more sender accounts and may further include user data, user device data (e.g., sender device identifiers), user preferences (e.g., payment preferences, communication preferences, transfer preferences), and/or the like for the sender.

In some embodiments, the asset transfer initiation request may further include a current location of the sender device. For example, the asset transfer initiation request may include geographic coordinates indicative of the current location of the sender device or may include a relative location with respect to a reference object.

In some embodiments, the communications hardware 206 may receive the asset transfer initiation request from the sender device (e.g., sender device 106A). The asset transfer initiation request may be received via a software application. By way of particular example, the asset transfer initiation request may be received via a mobile application from the sender device. In some embodiments, the asset transfer initiation request may further include a sender device identifier that uniquely identifies the sender device. For example, the sender device identifier may be a phone number, an international mobile equipment identity (IMEI), a serial number, a serial number, and/or the like. In some embodiments, the sender device may have an associated device profile within the sender user profile. This device profile may indicate the type of device, the device model, device version, etc. of the sender device. Additionally, the device profile may indicate a history of the software application usage by the sender device.

As shown by operation 404, the apparatus 200 may include means, such as processor 202, memory 204, communications hardware 206, and/or the like for receiving an indication of a recipient. A recipient may be a user with whom the sender wishes to transfer the asset indicated by the asset transfer initiation request. In some embodiments, the communications hardware 206 may receive the indication of the recipient via a recipient mDL authentication request. The recipient mDL authentication request may be a request to authenticate a recipient mDL associated with the recipient and thereby authenticate the identity of the recipient for an asset transfer. In some embodiments, the recipient mDL authentication request may be received from a sender device (e.g., sender device 106A). As described in more detail in FIGS. 10-15, the recipient device (e.g., any one of recipient devices 108A-108N) may provide the sender device with the recipient mDL authentication request and in turn, in some embodiments, the sender device may provide the recipient mDL authentication request to the communications hardware 206. In some embodiments, apparatus 200 may aid the sender device (e.g., sender device 106A) in identifying a recipient, as described in more detail in FIG. 9.

A recipient mDL authentication request may include one or more of cryptographic information (e.g., public key information) associated with a recipient mDL and/or a recipient device. Additionally, or alternatively, a recipient mDL authentication request may include one or more desired data elements (e.g., one or more desired portions of credential data) associated with the recipient mDL, location data, user profile data, user account data, social media data, smart mobile wallet identification data, user device identification data, and/or the like associated with the particular recipient. In some embodiments, the recipient mDL authentication request may further include the recipient identifier of the recipient and/or device identifier for the recipient device that provided the recipient mDL authentication request. As described in greater detail in operation 406, the transfer management circuitry 208 may use the information provided in the recipient mDL authentication request to identify the recipient user profile.

In some embodiments, the communications hardware 206 may receive the indication of the recipient in a communication other than the recipient mDL authentication. The indication of the recipient may be received from the sender device (e.g., sender device 106A) or a recipient device (e.g., recipient device 108A). For example, as described in further detail in FIGS. 10-15, in some embodiments, the recipient device (e.g., recipient device 108A) may provide the sender device with the recipient mDL authentication request the sender device may handle the authentication of the recipient. Thus, here the communications hardware 206 may receive an indication of the recipient in a separate communication. In some embodiments, the communications hardware 206 receives the indication of the recipient in the transfer initiation request, an individual communication, or in an authorization selection communication. In some embodiments, the indication of the recipient may correspond to a communication that includes the recipient identifier of the recipient, a recipient account identifier, and/or device identifier for the associated recipient device.

As shown by operation 406, the apparatus 200 may include means, such as processor 202, memory 204, communications hardware 206, transfer management circuitry 208, and/or the like, for selecting a recipient account associated with the recipient. Once the communications hardware 206 has received indication of the recipient (e.g., either in the recipient mDL authentication request or another communication), the transfer management circuitry 208 may select the recipient account associated with the recipient. The selected recipient account may correspond to a recipient account that may receive the asset.

The recipient may be associated with a recipient identifier, which may be a unique combination of numbers, letters, or a combination thereof that uniquely identify the recipient from other users. The recipient identifier may be associated with a recipient's user profile. As described above, a user profile for a recipient may be associated with one or more recipient accounts (e.g., credit account, checking account, savings account, investment account) and may further include user data, user device data (e.g., recipient device identifiers), user preferences (e.g., payment preferences, communication preferences, transfer preferences), and/or the like for the recipient. The recipient accounts may each be associated with a recipient account identifier, which may be a unique combination of numbers, letters, or a combination thereof that uniquely identifies the recipient account from other user accounts, including other recipient accounts.

Upon receipt of the indication of the recipient, the transfer management circuitry 208 may analyze the corresponding communication (e.g., the recipient mDL authentication request or another communication) to select the recipient account. For example, the transfer management circuitry 208 may identify a recipient identifier, a device identifier, a recipient account identifier, and/or the like within the communication that may be used to uniquely identify the recipient. The transfer management circuitry 208 may compare the corresponding values of the recipient identifier, device identifier, recipient account identifier, etc. to identify the corresponding recipient user profile. The transfer management circuitry 208 may be configured with a set of selection rules to select the recipient account associated with the recipient user profile. The set of selection rules may include one or more selection rules that indicate mathematical and/or logical operations for selecting a recipient account. For example, the set of selection rules may indicate that if there is only one recipient account associated with the recipient user profile, the transfer management circuitry 208 may identify this recipient account.

As another example, the set of selection rules may indicate that if there is more than one recipient account associated with the recipient user profile, the transfer management circuitry 208 should select the recipient account based on the user preferences in the recipient user profile and/or the type of asset indicated by the asset transfer initiation request. By way of particular example, the asset transfer initiation request may be indicative of monetary funds to transfer. The transfer management circuitry 208 may identify that the user preferences in the recipient user profile are indicative of a particular recipient account (e.g., a savings account) to receive monetary fund transfers. As another example, the asset transfer initiation request may be indicative of media to transfer and the transfer management circuitry 208 may identify that the user preferences in the recipient user profile are indicative to use a particular recipient account (e.g., an email account) to receive the asset.

As another example, the set of selection rules may indicate that if there is more than one recipient account associated with the recipient user profile and there are no user preferences for the particular type of asset indicated by the asset transfer initiation request, the transfer management circuitry 208 may select a default recipient account. For example, the transfer management circuitry 208 may be configured to a select a recipient account that was most recently used to receive an asset corresponding to the type of asset indicated in the asset transfer initiation request. As another example, the transfer management circuitry 208 may be configured to select the recipient account based on the type of assets that can be handled by a recipient account. For example, if the asset transfer initiation request is indicative of a transfer of media, the transfer management circuitry 208 may be configured to a ignore recipient account corresponding to payment accounts (e.g., credit accounts, checking accounts, savings accounts, investment accounts) as these recipient accounts are not configured to handle this type of asset transfer.

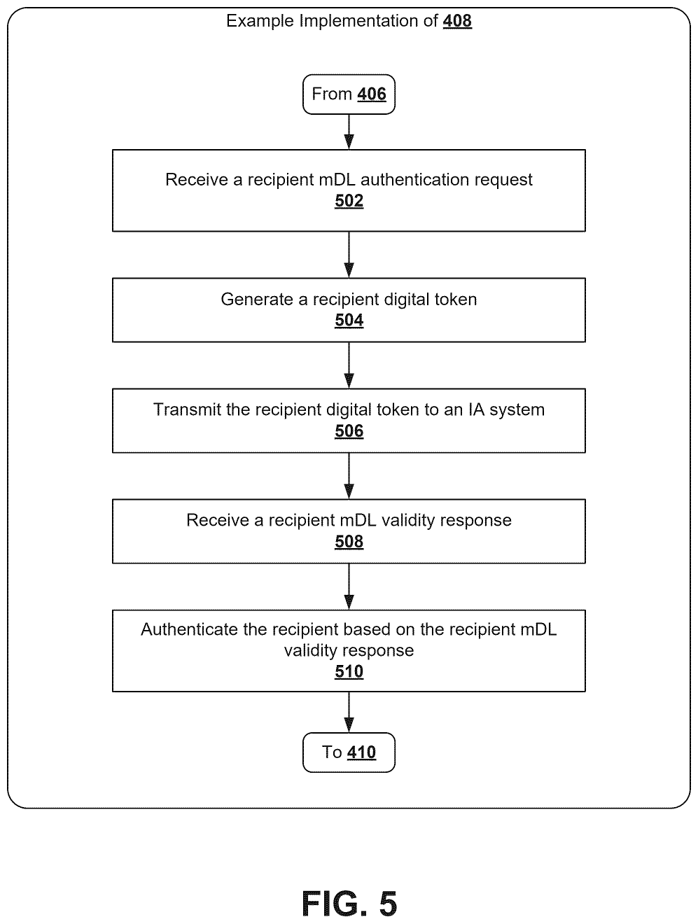

As shown by operation 408, the apparatus 200 may include means, such as processor 202, memory 204, communications hardware 206, authentication circuitry 210, and/or the like, for authenticating the recipient based on a recipient mDL. As described above, in some embodiments, the communications hardware 206 may be configured to receive a recipient mDL authentication request. In some embodiments, the recipient mDL authentication request may be received from a sender device (e.g., sender device 106A). As described in more detail in FIGS. 10-15, the recipient device (e.g., recipient device 108A) may provide the sender device with the recipient mDL authentication request and in turn, in some embodiments, the sender device may provide the recipient mDL authentication request to the communications hardware 206. In the instance that the recipient mDL authentication request is received by the communications hardware 206, the authentication circuitry 210 may be configured to authenticate the recipient based on a recipient mDL validity response, as described in more detail in FIG. 5.

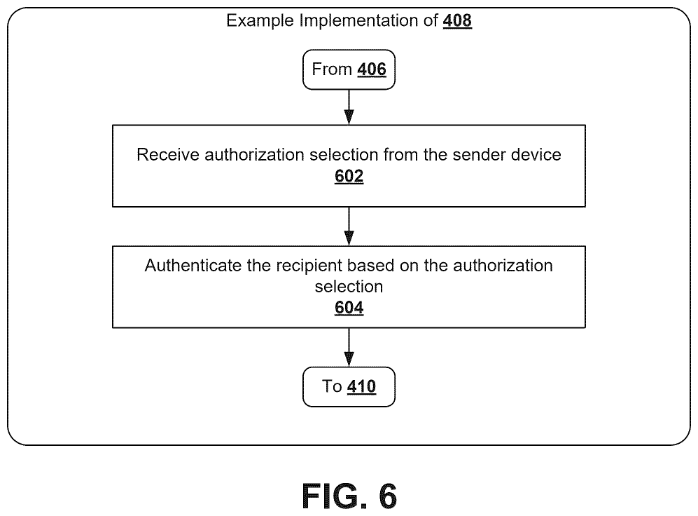

Additionally, or alternatively, in some embodiments, the authentication circuitry 210 may be configured to authenticate the recipient based on an authorization selection provided by the sender device (e.g., sender device 106A). As described above, in some embodiments, the sender device (e.g., sender device 106A) may handle the authentication of the recipient. In this instance, the authentication circuitry 210 may not receive the recipient mDL authentication request. Instead, the communications hardware 206 may receive an authorization selection from the sender device (e.g., sender device 106A). The authorization selection from the sender device may be indicative of whether the sender has successfully authenticated the recipient based on the recipient mDL. The authentication circuitry 210 may then successfully authenticate the recipient in an instance in which the authorization selection is indicative that the sender has successfully authenticated the recipient. The authentication circuitry 210 may determine that authentication of the recipient has failed in an instance in which the authorization selection is indicative that the sender has not authenticated the recipient. Thus, the authentication circuitry 210 may be configured to authenticate the recipient based on the authorization selection from the sender device (e.g., sender device 106A), as described in more detail in FIG. 6. The authentication process as handled by the sender device (e.g., sender device 106A) is described in further detail in FIGS. 10-12.

In some embodiments, a combination of authentication procedures may be contemplated. For example, in some embodiments the authentication circuitry 210 may only successfully authenticate the recipient in an instance in which the recipient is successfully authenticated based on a recipient mDL validity response, as described in FIG. 5, and in an instance in which the recipient is successfully authenticated based on an authorization selection received from the sender device (e.g., sender device 106A), as described in FIG. 6.

In some embodiments, operation 408 may be performed in accordance with the operations described by FIG. 5. Turning now to FIG. 5, example operations are shown for authenticating a recipient based on a recipient mDL authentication request.

As shown by operation 502, the apparatus 200 may include means, such as processor 202, memory 204, communications hardware 206, and/or the like for receiving a recipient mDL authentication request. The recipient mDL authentication request may be a request to authenticate a recipient mDL associated with the recipient and thereby authenticate the identity of the recipient for an asset transfer. As described above, the recipient mDL authentication request may include one or more of cryptographic information (e.g., public key information) associated with a recipient mDL and/or a recipient device. Additionally, or alternatively, a recipient mDL authentication request may include one or more desired data elements (e.g., one or more desired portions of credential data) associated with the recipient mDL, location data, user profile data, user account data, social media data, smart mobile wallet identification data, user device identification data, and/or the like associated with the particular recipient.

As shown by operation 504, the apparatus 200 may include means, such as processor 202, memory 204, authentication circuitry 210, and/or the like for generating a recipient digital token. In some embodiments, the authentication circuitry 210 may be configured to generate a recipient digital token comprising cryptographic information (e.g., public key information) associated with the recipient mDL of the recipient. Additionally, in some examples, the cryptographic information associated with the recipient mDL and comprised in the recipient digital token may be user device identification data by which the recipient device (e.g., recipient device 108A) of the recipient may be uniquely identified.

As shown by operation 506, the apparatus 200 may include means, such as processor 202, memory 204, communications hardware 206, and/or the like for transmitting the recipient digital token to an IA system. Once the recipient digital token is generated, the communications hardware 206 may provide the recipient digital token to an associated IA system. The communications hardware 206 may be configured to provide the recipient digital token to the IA system (e.g., IA system 110A) associated with the IA that provisioned the recipient mDL to the recipient such that the IA system (e.g., IA system 110A) may decrypt the cryptographic information comprised in the recipient digital token. In this manner, the IA system (e.g., IA system 110A) may authenticate (e.g., verify) one or more portions of credential data associated with the recipient mDL and/or one or more portions of user device identification data associated with the recipient device (e.g., recipient device 108A) of the recipient.

As shown by operation 508, the apparatus 200 may include means, such as processor 202, memory 204, communications hardware 206, and/or the like for receiving a recipient mDL validity response. The communications hardware 206 may be configured to receive a recipient mDL validity response from the IA system (e.g., IA system 110A) to which it provided the recipient digital token. In some embodiments, the recipient mDL validity response is generated by the IA system (e.g., IA system 110A) based on the recipient digital token. The recipient mDL validity response may be whether credential data (e.g., desired credential data) associated with the recipient mDL indicated by the recipient mDL authentication request was verified by the IA system. Furthermore, in some examples, the recipient mDL validity response may also indicate whether user device identification data related to the recipient device associated with the recipient (e.g., recipient device 108A) was verified by the IA system.

As shown by operation 510, the apparatus 200 may include means, such as processor 202, memory 204, authentication circuitry 210, and/or the like for authenticating the recipient based on the recipient mDL validity response. The authentication circuitry 210 may be configured to authenticate the recipient based on the data comprised in the recipient mDL validity response received from the IA system. Thus, the authentication circuitry 210 may be configured to determine whether the recipient has been successfully authenticated based on the recipient mDL validity response received. In some embodiments, the authentication circuitry 210 may successfully authenticate the recipient if the recipient mDL validity response is indicative that the credential data was verified. In some embodiments, the authentication circuitry 210 may successfully authenticate the recipient if the recipient mDL validity response is indicative that the credential data was verified and the user device identification data was verified. In some embodiments, if the authentication circuitry 210 determines that the recipient mDL validity response is indicative that the IA system failed to verify certain credential data and/or user device identification data, the authentication circuitry 210 may fail to authenticate the recipient.

In some embodiments, operation 408 may additionally, or alternatively, be performed in accordance with the operations described by FIG. 6. Turning now to FIG. 6, example operations are shown for authenticating a recipient based on an authorization selection.

As shown by operation 602, the apparatus 200 may include means, such as processor 202, memory 204, communications hardware 206, and/or the like, for receiving an authorization selection from the sender device. As described above, in some embodiments, the sender device (e.g., sender device 106A) may handle the authentication of the recipient. As described in further detail in FIGS. 10-12, the sender device may either receive user feedback indicative of whether to authenticate the recipient or may authenticate the recipient based on a received recipient mDL validity request. In the instance in which the sender device (e.g., sender device 106A) handles the authentication of the recipient, the communications hardware 206 may receive an authorization selection from the sender device. The authorization selection may be indicative of whether the sender has authenticated the recipient based on the recipient mDL.

As shown by operation 604, the apparatus 200 may include means, such as processor 202, memory 204, authentication circuitry 210, and/or the like for authenticating the recipient based on the authorization selection. The authentication circuitry 210 may authenticate the recipient based on the received authorization selection as received from the sender device (e.g., sender device 106A). In particular, the authentication circuitry 210 may successfully authenticate the recipient in an instance in which the authorization selection is indicative that the sender has successfully authenticated the recipient. The authentication circuitry 210 may fail to authenticate the recipient in an instance in which the authorization selection is indicative that the sender failed to successfully authenticate the recipient.

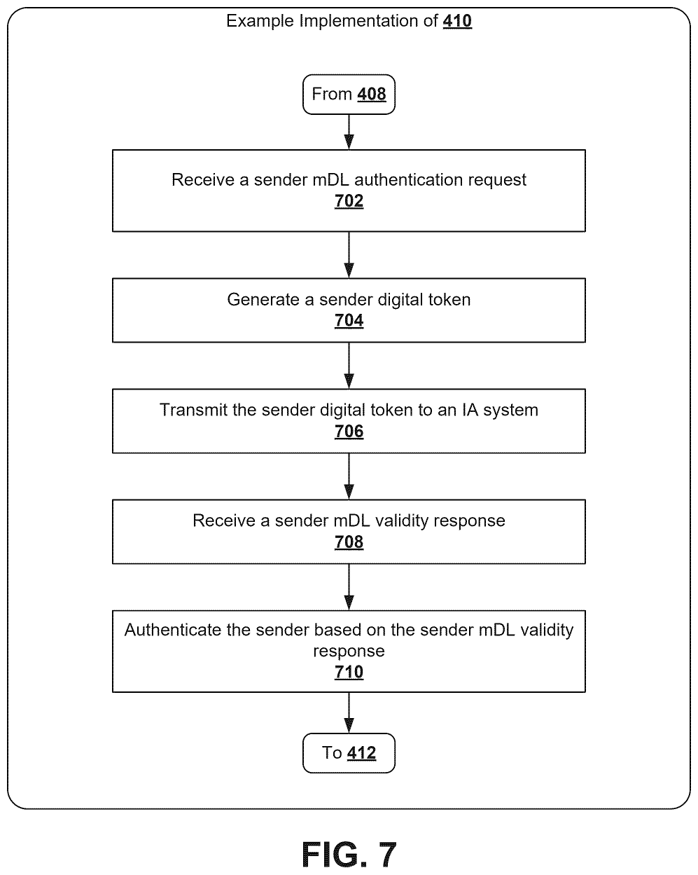

Returning now to FIG. 4, as shown by operation 410, the apparatus 200 may include means, such as processor 202, memory 204, communications hardware 206, authentication circuitry 210, and/or the like, for authenticating the sender based on a sender mDL. In some embodiments, the communications hardware 206 may be configured to receive a sender mDL authentication request. In some embodiments, the sender mDL authentication request may be received from a recipient device (e.g., recipient device 108A). As described in more detail in FIGS. 10-15, the sender device (e.g., sender device 106A) may provide the recipient device with the sender mDL authentication request and in turn, in some embodiments, the recipient device may provide the sender mDL authentication request to the communications hardware 206. In the instance that the sender mDL authentication request is received by the communications hardware 206, the authentication circuitry 210 may be configured to authenticate the sender based on a sender mDL validity response, as described in more detail in FIG. 7.

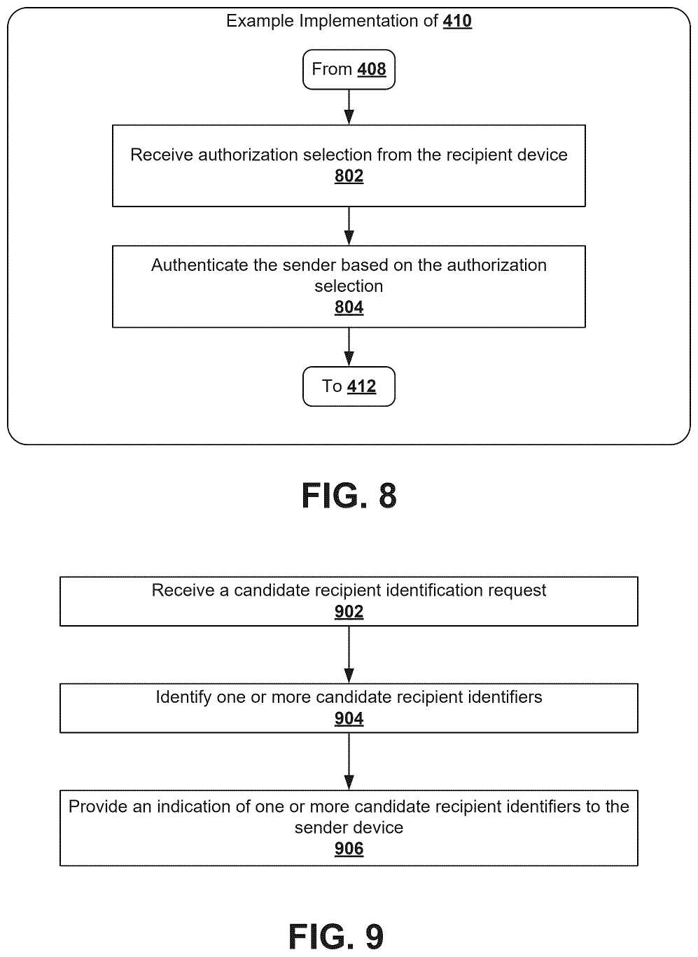

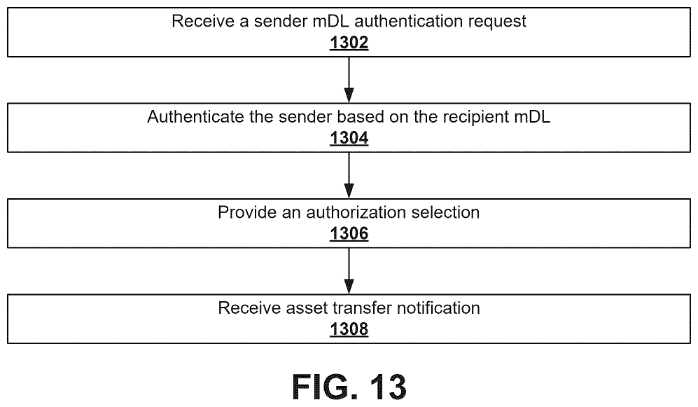

Additionally, or alternatively, in some embodiments, the authentication circuitry 210 may be configured to authenticate the sender based on an authorization selection provided by the recipient device (e.g., recipient device 108A). In some embodiments, the recipient device (e.g., recipient device 108A) may handle the authentication of the sender. In this instance, the authentication circuitry 210 may not receive the sender mDL authentication request. Instead, the communications hardware 206 may receive an authorization selection from the recipient device (e.g., recipient device 108A). The authorization selection from the recipient device may be indicative of whether the recipient has successfully authenticated the sender based on the sender mDL. The authentication circuitry 210 may successfully authenticate the sender in an instance in which the authorization selection is indicative that the recipient has successfully authenticated the sender. The authentication circuitry 210 determines that authentication of the sender has failed in an instance in which the authorization selection is indicative that the recipient has failed to authenticate the sender. Thus, the authentication circuitry 210 may be configured to authenticate the sender based on the authorization selection from the recipient device (e.g., recipient device 108A), as described in more detail in FIG. 8. The authentication process as handled by the recipient device (e.g., recipient device 108A) is described in further detail in FIGS. 13-15.

In some embodiments, a combination of authentication procedures may be contemplated. For example, in some embodiments the authentication circuitry 210 may only successfully authenticate the sender in an instance in which the sender is successfully authenticated based on a sender mDL validity response, as described in FIG. 7, and in an instance in which the sender is successfully authenticated based on an authorization selection received from the recipient device (e.g., recipient device 108A), as described in FIG. 8.

In some embodiments, operation 410 may be performed in accordance with the operations described by FIG. 7. Turning now to FIG. 7, example operations are shown for authenticating a sender based on a sender mDL authentication request.

As shown by operation 702, the apparatus 200 may include means, such as processor 202, memory 204, communications hardware 206, and/or the like for receiving a sender mDL authentication request. The sender mDL authentication request may be a request to authenticate a sender mDL associated with the sender and thereby authenticate the identity of the sender for an asset transfer. The sender mDL authentication request may be similar to the recipient mDL authentication request but may be specific to the sender. The sender mDL authentication request may include one or more of cryptographic information (e.g., public key information) associated with a sender mDL and/or a sender device. Additionally, or alternatively, a sender mDL authentication request may include one or more desired data elements (e.g., one or more desired portions of credential data) associated with the sender mDL, location data, user profile data, user account data, social media data, smart mobile wallet identification data, user device identification data, and/or the like associated with the particular sender.

As shown by operation 704, the apparatus 200 may include means, such as processor 202, memory 204, authentication circuitry 210, and/or the like for generating a sender digital token. In some embodiments, the authentication circuitry 210 may be configured to generate a sender digital token comprising cryptographic information (e.g., public key information) associated with the sender mDL of the sender. Additionally, in some examples, the cryptographic information associated with the sender mDL and comprised in the sender digital token may be user device identification data by which the sender device (e.g., sender device 106A) of the sender may be uniquely identified.

As shown by operation 706, the apparatus 200 may include means, such as processor 202, memory 204, communications hardware 206, and/or the like for transmitting the sender digital token to an IA system. Once the sender digital token is generated, the communications hardware 206 may provide the sender digital token to an associated IA system. The communications hardware 206 may be configured to provide the sender digital token to the IA system (e.g., IA system 110A) associated with the IA system that provisioned the sender mDL to the sender such that the IA system (e.g., IA system 110A) may decrypt the cryptographic information comprised in the sender digital token. The IA system that provisioned the sender mDL may be a different IA than the IA system that provisioned the recipient mDL. Alternatively, the same IA may have provisioned both the recipient mDL and sender mDL. The IA system (e.g., IA system 110A) may authenticate (e.g., verify) one or more portions of credential data associated with the sender mDL and/or one or more portions of user device identification data associated with the sender device (e.g., sender device 106A) of the sender.

As shown by operation 708, the apparatus 200 may include means, such as processor 202, memory 204, communications hardware 206, and/or the like for receiving a sender mDL validity response. The communications hardware 206 may be configured to receive a sender mDL validity response from the IA system (e.g., IA system 110A) to which it provided the sender digital token. In some embodiments, the sender mDL validity response is generated by the IA system (e.g., IA system 110A) based on the sender digital token. The sender mDL validity response may be whether credential data (e.g., desired credential data) associated with the sender mDL indicated by the sender mDL authentication request was verified by the IA system. Furthermore, in some examples, the sender mDL validity response may also indicate whether user device identification data related to the sender device associated with the sender (e.g., sender device 106A) was verified by the IA system.

As shown by operation 710, the apparatus 200 may include means, such as processor 202, memory 204, authentication circuitry 210, and/or the like for authenticating the sender based on the sender mDL validity response. The authentication circuitry 210 may be configured to authenticate the sender based on the data comprised in the sender mDL validity response received from the IA system. Thus, the authentication circuitry 210 may be configured to determine whether the sender has been successfully authenticated based on the sender mDL validity response received. In some embodiments, the authentication circuitry 210 may successfully authenticate the sender if the sender mDL validity response is indicative that the credential data was verified. In some embodiments, the authentication circuitry 210 may successfully authenticate the sender if the sender mDL validity response is indicative that the credential data was verified and the user device identification data was verified. In some embodiments, if the authentication circuitry 210 determines that the sender mDL validity response is indicative that the IA system failed to verify certain credential data and/or user device identification data, the authentication circuitry 210 may fail to authenticate the sender.

In some embodiments, operation 410 may additionally, or alternatively, be performed in accordance with the operations described by FIG. 8. Turning now to FIG. 8, example operations are shown for authenticating a sender based on an authorization selection.

As shown by operation 802, the apparatus 200 may include means, such as processor 202, memory 204, communications hardware 206, and/or the like for receiving an authorization selection from the recipient device. As described above, in some embodiments, the recipient device (e.g., recipient device 108A) may handle the authentication of the sender. As described in further detail in FIGS. 13-15, the recipient device may either receive user feedback indicative of whether to authenticate the sender or may authenticate the sender based on a received sender mDL validity request. In the instance in which the recipient device (e.g., recipient device 108A) handles the authentication of the sender, the communications hardware 206 may receive an authorization selection from the recipient device. The authorization selection may be indicative of whether the recipient has authorized transfer of the asset to the sender based on the sender mDL.

As shown by operation 804, the apparatus 200 may include means, such as processor 202, memory 204, authentication circuitry 210, and/or the like for authenticating the sender based on the authorization selection. The authentication circuitry 210 may authenticate the sender based on the received authorization selection as received from the recipient device (e.g., recipient device 108A). In particular, the authentication circuitry 210 may successfully authenticate the sender in an instance in which the authorization selection is indicative that the recipient has successfully authenticated the sender. The authentication circuitry 210 may fail to authenticate the sender in an instance in which the authorization selection is indicative that the recipient failed to successfully authenticate the sender.

Returning now to FIG. 4, as shown by operation 412, the apparatus 200 may include means, such as processor 202, memory 204, authentication circuitry 210, and/or the like for determining whether the sender and recipient have been successfully authenticated. As described above in operation 408, the authentication circuitry 210 may determine whether the recipient is successfully authenticated based on the recipient mDL. As described above in operation 410, the authentication circuitry 210 may determine whether the sender is successfully authenticated based on the sender mDL.

In an instance in which either the sender or recipient has failed to be successfully authenticated, the process proceeds to operation 414. As shown by operation 414, the apparatus 200 may include means, such as processor 202, memory 204, communications hardware 206, authentication circuitry 210, and/or the like for providing a transfer failure notification. If the authentication circuitry 210 fails to authenticate the sender and/or the recipient, the authentication circuitry 210 may be configured to deny the asset transfer initiation request and generate a transfer failure notification. The transfer failure notification may be indicative that the asset transfer indicated in the asset transfer initiation request is unable to be completed because one or more of the sender or recipient was unable to be authenticated. In some embodiments, the transfer failure notification may be indicative of the party that failed to be successfully authenticated by the authentication circuitry 210.

The communications hardware 206 may be configured to provide the transfer failure notification to the sender device (e.g., sender device 106A) and/or recipient device (e.g., recipient device 108A). The transfer failure notification may be configured as a notification, email, text message, direct application message (e.g., via a software application), audio message (e.g., automated voice message), banner notification, and/or the like.

In an instance in which both the sender and recipient have been successfully authenticated, the process proceeds to operation 416. As shown by operation 416, the apparatus 200 may include means, such as processor 202, memory 204, transfer management circuitry 208, and/or the like for effectuating a transfer of the asset. The transfer management circuitry 208 may effectuate the transfer of the asset indicated in the asset transfer initiation request from the indicated sender account to the selected recipient account. For example, if the asset indicated in the asset transfer initiation request indicated an asset of $30 from the sender's checking account, the transfer management circuitry 208 may cause the $30 to be transferred from the sender's checking account to a selected recipient checking account associated with the recipient. As another example, if the asset indicated in the asset transfer initiation request indicated an image (e.g., media) from a sender's account, the transfer management circuitry 208 may be configured to provide the image to the recipient's email. In some embodiments, the sender's account may still retain the original media and the recipient account may be provided a copy of the media. Alternatively, the media may be transferred to the recipient account and the media may be deleted from the sender's account.

In some embodiments, the method of transfer may be dependent upon user preferences in the recipient profile and/or user preferences in the sender profile. For example, the recipient profile may include user preferences indicative of one or more preferred payment rails of the recipient when receiving monetary funds. The sender profile may also include user preferences indicative of one or more preferred payment rails when transferring monetary funds. In some embodiments, the transfer management circuitry 208 may consider only the recipient preferences and effectuate the transfer in accordance with the recipient's transfer preferences. In some embodiments, the transfer management circuitry 208 may consider only the sender preferences and effectuate the transfer in accordance with the sender's transfer preferences. In some embodiments, the transfer management circuitry 208 may consider both the recipient preferences and sender preferences and may effectuate a transfer in accordance with a preference indicated in both the sender profile and recipient profile.

As shown by operation 418, the apparatus 200 may include means, such as processor 202, memory 204, communications hardware 206, transfer management circuitry 208, and/or the like for providing a transfer notification. Once the transfer management circuitry 208 has effectuated the transfer of the asset from the sender account to the recipient account, the transfer management circuitry 208 may generate a transfer notification. The transfer notification may provide confirmation that the parties were both successfully authenticated and/or that transfer of the asset has occurred. The communications hardware 206 may be configured to provide the transfer notification to the sender device (e.g., sender device 106A) and/or recipient device (e.g., recipient device 108A). The transfer notification may be configured as a notification, email, text message, direct application message (e.g., via a software application), audio message (e.g., automated voice message), banner notification, and/or the like.

As shown by operation 420, the apparatus 200 may include means, such as processor 202, memory 204, transfer management circuitry 208, and/or the like for updating the sender account and the recipient account to reflect the asset transfer. Once the transfer management circuitry 208 has effectuated the transfer, the transfer management circuitry 208 may be configured to update the sender account and recipient account to reflect the transfer of the asset such that the asset transfer is logged, and pertinent details are available within the associated user account. As such, the sender may view the details of the asset transfer within his/her sender account and the recipient may view details of the asset transfer within his/her recipient account.

In some embodiments, the asset transfer details may include an indication of the type of asset transferred, the date and/or a time stamp of the transfer, a recipient identifier, a sender identifier, whether the recipient was successfully authenticated, the manner in which the recipient was successfully authenticated, whether the sender was successfully authenticated, the manner in which the sender was successfully authenticated, and/or the like. In some embodiments, the asset transfer details for the sender may reflect the sender account from which the asset was transferred from. This may not be included in the asset transfer details of the recipient. In some embodiments, the asset transfer details for the recipient may reflect the recipient account that received the asset. This may not be included in the asset transfer details of the sender. As such, asset transfer details of the asset transfer may be accessible to both the recipient and the sender. In an instance in which either the sender or recipient requires assistance with a previously executed asset transfer, he/she may use access his/her account to view the relevant details.

Turning next to FIG. 9, the flowchart illustrates example operations for facilitating providing candidate recipient identifiers to a sender device. As shown by operation 902, the apparatus 200 may include means, such as processor 202, memory 204, communications hardware 206, and/or the like for receiving a candidate recipient identification request. In some embodiments, the communications hardware 206 may receive a candidate recipient identification request from the sender device (e.g., sender device 106A). The candidate recipient identification request may include a current location of the sender device and may be indicative of a request to identify one or more candidate recipients within a predefined proximity of the sender device.

As shown by operation 904, the apparatus 200 may include means, such as processor 202, memory 204, communications hardware 206, transfer management circuitry 208, and/or the like, for identifying one or more candidate recipient identifiers. Responsive to receiving the candidate recipient identification request, the transfer management circuitry 208 may identify one or more candidate recipient identifiers. In some embodiments, the communications hardware 206 may receive current location data from candidate recipient devices. For example, the communications hardware 206 may receive current location data from candidate recipient devices that are currently running the software application actively or in the background. The transfer management circuitry 208 may use this location data from these candidate recipient devices to determine whether the candidate recipient device is within a predefined proximity of the location of the sender device (e.g., within 10 feet). The transfer management circuitry 208 may identify the candidate recipient devices within the predefined proximity and use the associated recipient device identifier and/or recipient identifier associated with the location to identify the one or more candidate recipient identifiers.

In an instance in which the location data is associated with a recipient device identifier and not a recipient identifier, the transfer management circuitry 208 may identify the recipient identifier using the recipient device identifier. As described above, a recipient's user profile may include recipient device identifiers. As such, the transfer management circuitry 208 may identify the recipient user profile that includes the recipient device identifier. The recipient user profile may be associated with a recipient identifier such that the transfer management circuitry 208 may identify the recipient identifier from the recipient user profile.

As shown by operation 906, the apparatus 200 may include means, such as processor 202, memory 204, communications hardware 206, and/or the like for providing an indication of the one or more candidate recipient identifiers to the sender device. Once the transfer management circuitry 208 has identified the one or more candidate recipient identifiers within the predefined proximity of the sender device (e.g., sender device 106A), the communications hardware 206 may be configured to provide the sender device with an indication of the one or more candidate recipient identifiers. In this way, the sender device may be provided with an indication of the nearby candidate recipients and may select a recipient accordingly. The indication of the candidate recipient identifier may include only a limited recipient information. For example, an indication of the candidate recipient identifier may include a first name of the candidate recipient and a last name initial, the candidate recipient's full name, a picture associated with the candidate recipient profile, and/or the like.

### Sender Device Example Operations

Turning next to FIGS. 10-12, example flowcharts are illustrated that contain example operations implemented by example embodiments described herein. The operations illustrated in FIGS. 10-12 may, for example, be performed by a sender device (e.g., any one of sender devices 106A-106N shown in FIG. 1), which may in turn be embodied by an apparatus 300, which is shown and described in connection with FIG. 3. To perform the operations described below, the apparatus 300 may utilize one or more of processor 302, memory 304, communications hardware 306, authentication circuitry 310, user interface circuitry 312, and/or any combination thereof.

Turning first to FIG. 10, the flowchart illustrates example operations for facilitating an asset transfer to a recipient. As shown by operation 1002, the apparatus 300 may include means, such as processor 302, memory 304, communications hardware 306, user interface circuitry 312, smart mobile wallet circuitry 314, and/or the like for providing an asset transfer initiation request. A sender may use apparatus 300 to use a software application to generate an asset transfer initiation request. The sender may log into an associated user profile and/or sender account via the software application. Once successfully logged into the software application, the sender may interact with the software application to facilitate the asset transfer process.

In particular, the sender may use the software application to select an asset from a sender account. As described in FIG. 4, an asset may include any item, resource, or the like that belongs to the sender, either wholly or in part. For example, an asset may be monetary funds, a financial instrument, media (e.g., pictures, videos, etc.), documents, information, data and/or the like. The sender may select an asset (e.g., $30) from a sender account. The user interface circuitry 312 may be configured to display the current assets available from one or more sender accounts associated with the sender profile. Once the sender has selected and finalized an asset selection, the communications hardware 306 may be configured to provide an asset transfer initiation request to the asset transfer management system 102. The asset transfer initiation request may further include a sender account identifier associated with the sender account from which the asset was selected to be transferred.

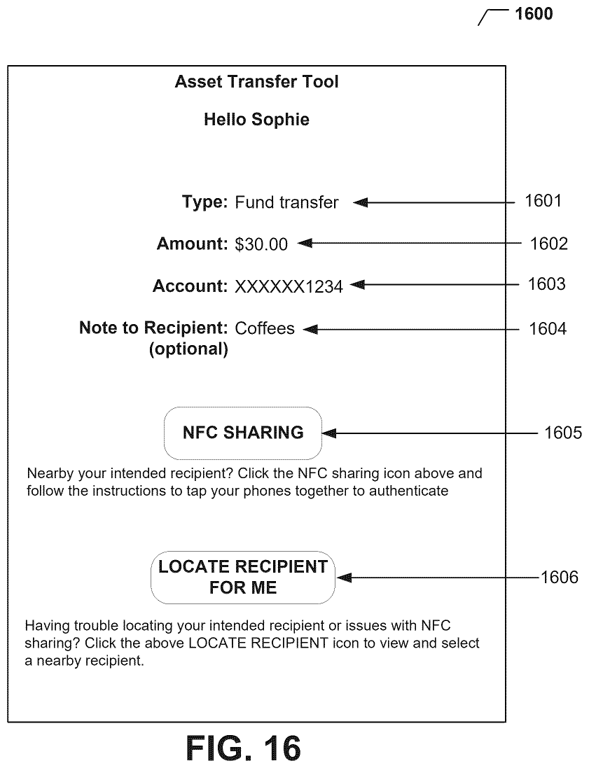

As illustrated in FIG. 16, an example user interface 1600, which may be associated with recipient's smart mobile wallet, may include one or more interactive user interface elements (e.g., interactive user interface elements 1605-1606) and one or more values for various asset transfer fields (e.g., values 1601-1604). In some embodiments, the sender may use user interface 1600 to generate and provide the asset transfer initiation request. In particular, the sender may provide values for various asset transfer fields to begin the asset transfer process. For example, the sender may supply a value of “fund transfer” for the “type” asset transfer field 1601. This may be indicative of the type of asset for the asset transfer. The sender may also supply a value of “$30.00” for the “amount” asset transfer field 1602. This may describe the particular asset to be transferred to the recipient. The sender may also supply a value for the “account” asset transfer field 1603. This value may describe the sender account from which the asset will be transferred. The sender may also supply a value for the “note to recipient” asset transfer field 1604. This may provide context to the recipient to notify him/her of what the asset transfer is for. This field may also be included in the asset transfer details for the sender and the recipient in their respective accounts.

In various examples, the one or more interactive user interface elements may be configured as interactive buttons that may be utilized to initiate various commands (e.g., executable software instructions) based one or more interactions (e.g., selections, indications, manipulations) with the interactive user interface elements. For example, if the user interacts with interactive user interface element 1605, apparatus 300 may be configured to receive a sender mDL authentication request using near-field communication (NFC) as described in more detail in operation 1004. Alternatively, if the user interacts with interactive user interface element 1606, the apparatus may be configured to provide a candidate recipient identification request to the asset transfer management system 102.

As shown by operation 1004, the apparatus 300 may include means, such as processor 302, memory 304, communications hardware 306, user interface circuitry 312, and/or the like for selecting a recipient. In some embodiments, the sender and recipient may be within a close proximity of one another. As such, the communications hardware 306 may use NFC to receive a recipient mDL authentication request from the recipient device (e.g., recipient device 108A) and/or provide a sender mDL authentication request to the recipient device. For example, apparatus 300 and the recipient device 108A may be physically tapped together to cause the transfer of respective mDL authentication requests. The communications hardware 306 may detect that the apparatus 300 is within a predefined threshold of another device emitting NFC signals (i.e., the recipient device 108A) and an accelerometer of the apparatus 300 may detect that apparatus 300 has been tapped at a time coextensive with the close proximity to the other device. Upon detection these events occurring, the communications hardware 306 may broadcast the recipient mDL authentication request. Similar components of the recipient device 108A may operate similarly, such that the recipient device 108A transmits (and communications hardware 306 receives) the recipient mDL authentication request. As such, in some embodiments, the recipient device may be selected based on the recipient mDL authentication requests exchanged as a result of the NFC interaction.

Alternatively, in some examples, the recipient and sender may not be sufficiently proximate to one another, apparatus 300 and/or the recipient device (e.g., recipient device 108A) may lack the hardware necessary for NFC interactions, etc. As such, in some embodiments, the communications hardware 306 may provide a candidate recipient identification request to asset transfer management system 102. In some examples, the candidate recipient identification request is provided within the software application. In response, the communications hardware 306 may receive an indication of one or more candidate recipient identifiers. The user interface circuitry 312 may be configured to cause display of the indication of the one or more candidate recipient identifiers such that the sender may select a recipient. For example, an indication of the candidate recipient identifier may include a first name of the candidate recipient and a last name initial, the candidate recipient's full name, a picture associated with the candidate recipient profile, and/or the like. The sender may select (e.g., click, touch, audibly select) an intended recipient within the software application.

The selection of the recipient is provided to the asset transfer management system 102. In some embodiments, the selection of the recipient is provided within a recipient mDL authentication request. In some embodiments, the selection of the recipient is provided within an authorization selection. In some embodiments, the selection of the recipient may be provided in a communication other than the recipient mDL authentication request or the authorization selection.

As shown by operation 1006, the apparatus 300 may include means, such as processor 302, memory 304, communications hardware 306, smart mobile wallet circuitry 314, and/or the like, for receiving a recipient mDL authentication request. Once apparatus 300 has selected the recipient, communications hardware 306 may receive a recipient mDL authentication request from the recipient device (e.g., recipient device 108A). A recipient mDL authentication request may include one or more of cryptographic information (e.g., public key information) associated with a recipient mDL and/or a recipient device. Additionally, or alternatively, a recipient mDL authentication request may include one or more desired data elements (e.g., one or more desired portions of credential data) associated with the recipient mDL, location data, user profile data, user account data, social media data, smart mobile wallet identification data, user device identification data, and/or the like associated with the particular recipient. In some embodiments, the recipient mDL authentication request may further include the recipient identifier of the recipient and/or device identifier for the recipient device that provided the recipient mDL authentication request.

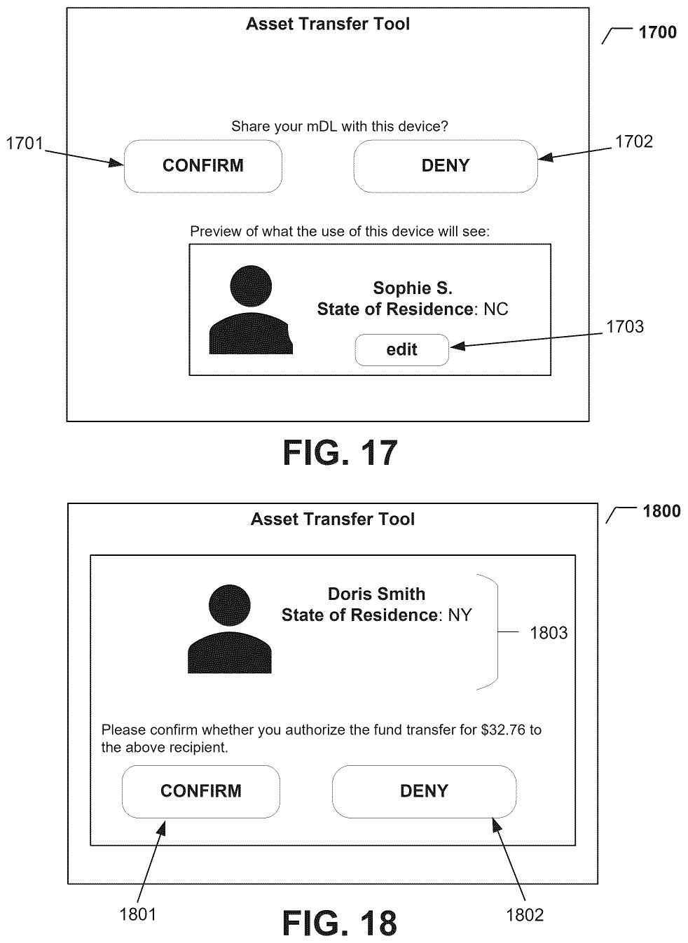

In some embodiments, the communications hardware 306 may also generate and provide a sender mDL authentication request to a recipient device (e.g., recipient device 108A). As illustrated in FIG. 17, an example user interface 1700, which may be associated with recipient's smart mobile wallet, may include one or more interactive user interface elements (e.g., interactive user interface elements 1701-1703) and a digital representation of a sender mDL. In various examples, the one or more interactive user interface elements may be configured as interactive buttons that may be utilized to initiate various commands (e.g., executable software instructions) based one or more interactions (e.g., selections, indications, manipulations) with the interactive user interface elements.

In some embodiments, in order to provide a sender mDL authentication request to the recipient device, the communications hardware 306 may first require responsive confirmation from the sender. As such, the sender may be required to select interactive user interface element 1701 to authorize the communications hardware 306 to provide the sender mDL authentication request to the recipient device. If the sender selects interactive user interface element 1702, the communications hardware 306 may fail to provide the sender mDL authentication request to the recipient device because it has not received confirmation to do so.

In some embodiments, the sender may use interactive user interface element 1703 to edit the digital representation of the sender mDL. For example, the sender may use interactive user interface element 1703 to select the fields within an associated sender mDL to provide a sender mDL authentication request. As such, the sender may exert control over his/her mDL and the associated information provided to the recipient and available for authentication.

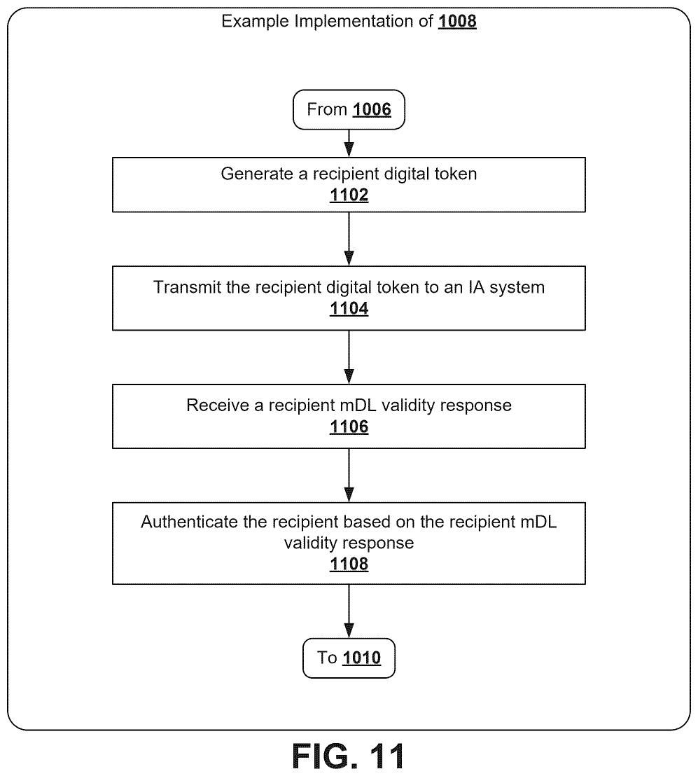

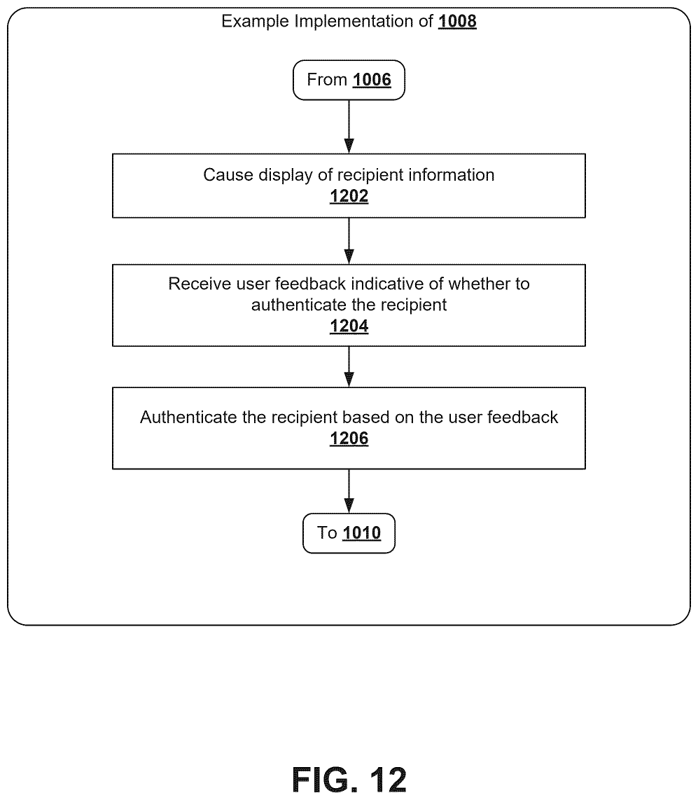

As shown by operation 1008, the apparatus 300 may include means, such as processor 302, memory 304, communications hardware 306, authentication circuitry 310, smart mobile wallet circuitry 314, and/or the like, for authenticating the recipient based on the recipient mDL. In some embodiments, the authentication circuitry 310 may be configured to authenticate the recipient using the recipient mDL authentication request, as described in more detail in FIG. 11. Additionally, or alternatively, in some embodiments, the authentication circuitry 310 may be configured to authenticate the recipient based on user feedback, as described in more detail in FIG. 12. In some embodiments, a combination of authentication procedures may be contemplated. For example, in some embodiments, the authentication circuitry 310 may only successfully authenticate the recipient in an instance in which the recipient is successfully authenticated based on a recipient mDL validity response, as described in FIG. 11, and in an instance in which the recipient is successfully authenticated based on user feedback, as described in FIG. 12.

In some embodiments, the communications hardware 306 may provide the recipient mDL authentication request to the asset transfer management system 102 and in turn, the asset transfer management system 102 may handle the authentication of the recipient.

In some embodiments, operation 1008 may be performed in accordance with the operations described by FIG. 11. Turning now to FIG. 11, example operations are shown for authenticating a recipient with an IA system.

As shown by operation 1102, the apparatus 300 may include means, such as processor 302, memory 304, authentication circuitry 310, smart mobile wallet circuitry 314, and/or the like for generating a recipient digital token. In particular, authentication circuitry 310 may generate a recipient digital token comprising cryptographic information (e.g., public key information) associated with the recipient mDL of the recipient. In some embodiments, operation 1102 may be performed in a substantially similar manner as described above with respect to operation 504 of FIG. 5.

As shown by operation 1104, the apparatus 300 may include means, such as processor 302, memory 304, communications hardware 306, authentication circuitry 310, and/or the like for transmitting the recipient digital token to an IA system. The communications hardware 306 may be configured to provide the recipient digital token to the IA system (e.g., IA system 110A) associated with the IA that provisioned the recipient mDL to the recipient such that the IA system (e.g., IA system 110A) may decrypt the cryptographic information comprised in the recipient digital token. In some embodiments, operation 1104 may be performed in a substantially similar manner as described above with respect to operation 506 of FIG. 5.

As shown by operation 1106, the apparatus 300 may include means, such as processor 302, memory 304, communications hardware 306, and/or the like for receiving a recipient mDL validity response. The recipient mDL validity response may be whether credential data (e.g., desired credential data) associated with the recipient mDL indicated by the recipient mDL authentication request was verified by the IA system. In some embodiments, operation 1106 may be performed in a substantially similar manner as described above with respect to operation 508 of FIG. 5.

As shown by operation 1108, the apparatus 300 may include means, such as processor 302, memory 304, authentication circuitry 310, smart mobile wallet circuitry 314, and/or the like for authenticating the recipient based on the recipient mDL validity response. The authentication circuitry 310 may be configured to authenticate the recipient based on the data comprised in the recipient mDL validity response received from the IA system. In some embodiments, operation 1108 may be performed in a substantially similar manner as described above with respect to operation 510 of FIG. 5.

In some embodiments, operation 1008 may additionally, or alternatively, be performed in accordance with the operations described by FIG. 12. Turning now to FIG. 12, example operations are shown for authenticating a recipient based on user feedback.

As shown by operation 1202, the apparatus 300 may include means, such as processor 302, memory 304, communications hardware 306, user interface circuitry 312, smart mobile wallet circuitry 314, and/or the like for causing display of recipient information. In some embodiments, recipient information may include information associated with the recipient mDL. For example, recipient information may include recipient identification data, desired credential data, or user attribute data. The recipient information may be obtained from the recipient mDL authentication request. The user interface circuitry 312 may then cause display of the recipient information such that the sender may view this recipient information. The user interface circuitry 312 may display the recipient information within the software application.

As shown by operation 1204, the apparatus 300 may include means, such as processor 302, memory 304, communications hardware 306, user interface circuitry 312, and/or the like for receiving user feedback indicative of whether to authenticate the recipient. The communications hardware 306 may then receive user feedback indicative of whether to authenticate the recipient based on the displayed recipient information. For example, the sender may view the displayed recipient information to determine whether the displayed recipient information matches the description, image, or known attributes of the nearby individual and/or intended recipient. Thus, the sender may interact with apparatus 300 to provide user feedback indicative of whether to authenticate the recipient. For example, within the software application, the sender may be able to select an option of “authenticate” or “do not authenticate” to provide user feedback. If the sender selects the “authenticate” option, the sender may provide user feedback indicative to authenticate the recipient. However, if the sender selects the “do not authenticate” option, the sender may provide user feedback indicative to not authenticate the recipient.

As shown by operation 1206, the apparatus 200 may include means, such as processor 302, memory 304, authentication circuitry 310, and/or the like for authenticating the recipient based on the user feedback. Authentication circuitry 310 may determine whether the user feedback is indicative to authenticate the recipient. In an instance in which the user feedback is indicative to authenticate the recipient, the authentication circuitry 310 may successfully authenticate the recipient. In an instance in which the user feedback fails to be indicative to authenticate the recipient, the authentication circuitry 310 may fail to successfully authenticate the recipient.

As illustrated in FIG. 18, an example user interface 1800, which may be associated with recipient's smart mobile wallet, may include one or more interactive user interface elements (e.g., interactive user interface elements 1801 and 1802) and a digital representation of the recipient information 1803. In various examples, the one or more interactive user interface elements may be configured as interactive buttons that may be utilized to initiate various commands (e.g., executable software instructions) based one or more interactions (e.g., selections, indications, manipulations) with the interactive user interface elements.

The sender may view the displayed recipient information 1803 and may determine whether to authenticate the recipient based on this displayed information. The sender may then interact with interactive user interface element 1801 to confirm authentication of the recipient based on the displayed recipient information 1803. Alternatively, the sender may interact with interactive user interface element 1802 to deny authentication of the recipient.

Returning now to FIG. 10, as shown by operation 1010, the apparatus 300 may include means, such as processor 302, memory 304, communications hardware 306, and/or the like for providing an authorization selection. Once authentication circuitry 310 has authenticated the recipient, the communications hardware 306 may provide an authorization selection to the asset transfer management system 102. The authorization selection may be indicative of whether the sender has successfully authenticated the recipient based on the recipient mDL. In some embodiments, the authorization selection may further be indicative of the manner in which the sender authenticated the recipient.

As shown by operation 1012, the apparatus 300 may include means, such as processor 302, memory 304, communications hardware 306, user interface circuitry 312, and/or the like for receiving an asset transfer notification. As described above in FIG. 4, the transfer notification may provide confirmation that the parties were both successfully authenticated and/or that transfer of the asset has occurred. The transfer notification may be received as a notification, email, text message, direct application message (e.g., via a software application), audio message (e.g., automated voice message), banner notification, and/or the like. In some embodiments, user interface circuitry 312 may be configured to display the transfer notification on an associated display. As such, the sender may be informed that the asset transfer was successful.

### Recipient Device Example Operations

Turning next to FIGS. 13-15, example flowcharts are illustrated that contain example operations implemented by example embodiments described herein. The operations illustrated in FIGS. 13-15 may, for example, be performed by a recipient device (e.g., any one of recipient devices 108A-108N shown in FIG. 1), which may in turn be embodied by an apparatus 300, which is shown and described in connection with FIG. 3. To perform the operations described below, the apparatus 300 may utilize one or more of processor 302, memory 304, communications hardware 306, authentication circuitry 310, user interface circuitry 312, and/or any combination thereof.

Turning first to FIG. 13, the flowchart illustrates example operations for facilitating an asset transfer from a sender. As shown by operation 1302, the apparatus 300 may include means, such as processor 302, memory 304, communications hardware 306, smart mobile wallet circuitry 314, and/or the like, for receiving a sender mDL authentication request. As described above in FIG. 10, a sender may initiate an asset transfer with a recipient and communications hardware 306 may receive a sender mDL authentication request from sender device (e.g., sender device 106A). A sender mDL authentication request may include one or more of cryptographic information (e.g., public key information) associated with a sender mDL and/or a sender device. Additionally, or alternatively, a sender mDL authentication request may include one or more desired data elements (e.g., one or more desired portions of credential data) associated with the sender mDL, location data, user profile data, user account data, social media data, smart mobile wallet identification data, user device identification data, and/or the like associated with the particular sender. In some embodiments, the sender mDL authentication request may further include the sender identifier of the sender and/or device identifier for the sender device that provided the sender mDL authentication request. In some embodiments, the communications hardware 306 may also generate and provide a recipient mDL authentication request to a sender device (e.g., sender device 106A).

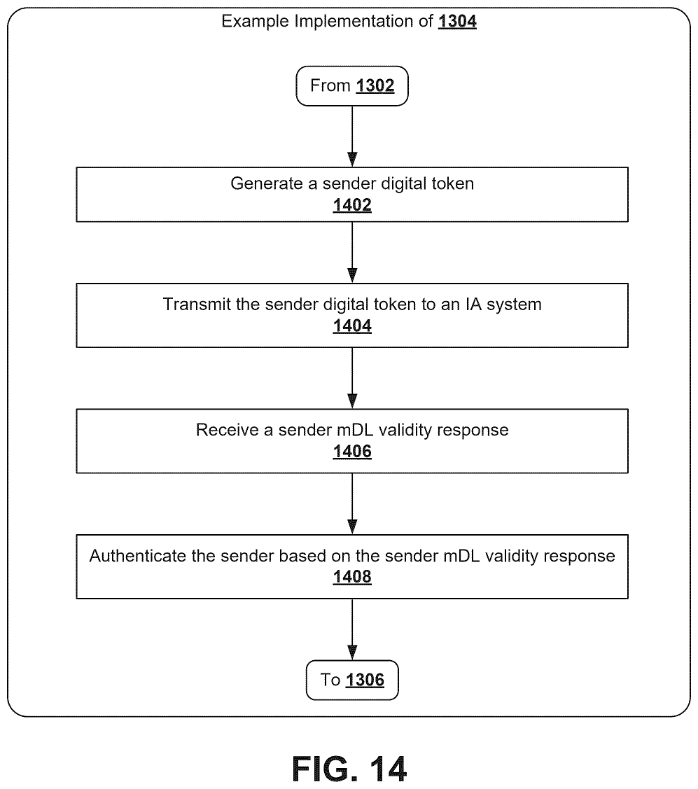

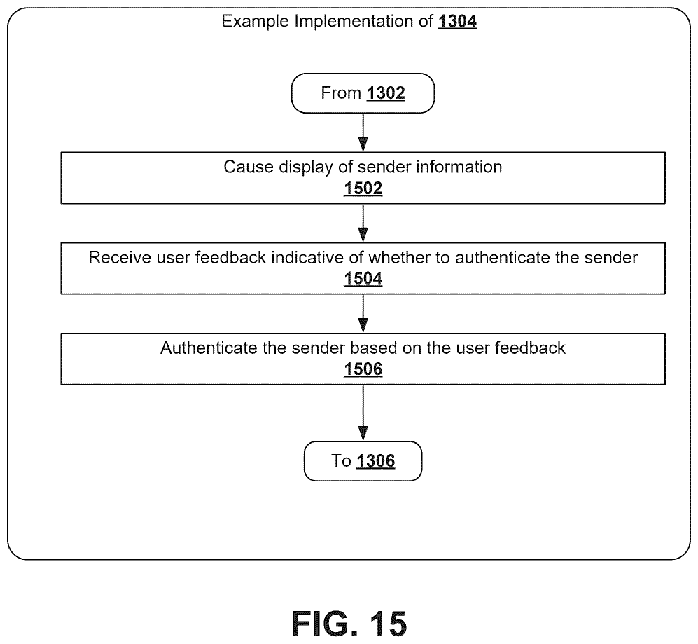

As shown by operation 1304, the apparatus 300 may include means, such as processor 302, memory 304, communications hardware 306, authentication circuitry 310, smart mobile wallet circuitry 314, and/or the like for authenticating the sender based on the sender mDL. In some embodiments, the authentication circuitry 310 may be configured to authenticate the sender using the sender mDL authentication request, as described in more detail in FIG. 14. Additionally, or alternatively, in some embodiments, the authentication circuitry 310 may be configured to authenticate the sender based on user feedback, as described in more detail in FIG. 15. In some embodiments, a combination of authentication procedures may be contemplated. For example, in some embodiments the authentication circuitry 310 may only successfully authenticate the sender in an instance in which the sender is successfully authenticated based on a sender mDL validity response, as described in FIG. 14, and in an instance in which the sender is successfully authenticated based user feedback, as described in FIG. 15.

In some embodiments, the communications hardware 306 may provide the sender mDL authentication request to the asset transfer management system 102 and in turn, the asset transfer management system 102 may handle the authentication of the sender.

In some embodiments, operation 1304 may be performed in accordance with the operations described by FIG. 14. Turning now to FIG. 14, example operations are shown for authenticating a sender with an IA system.

As shown by operation 1402, the apparatus 300 may include means, such as processor 302, memory 304, authentication circuitry 310, smart mobile wallet circuitry 314, and/or the like for generating a sender digital token. In particular, authentication circuitry 310 may generate a sender digital token comprising cryptographic information (e.g., public key information) associated with the sender mDL of the sender. In some embodiments, operation 1402 may be performed in a substantially similar manner as described above with respect to operation 704 of FIG. 7.

As shown by operation 1404, the apparatus 300 may include means, such as processor 302, memory 304, communications hardware 306, authentication circuitry 310, smart mobile wallet circuitry 314, and/or the like for transmitting the sender digital token to an IA system. The communications hardware 306 may be configured to provide the sender digital token to the IA system (e.g., IA system 110A) associated with the IA that provisioned the sender mDL to the sender such that the IA system (e.g., IA system 110A) may decrypt the cryptographic information comprised in the sender digital token. In some embodiments, operation 1404 may be performed in a substantially similar manner as described above with respect to operation 706 of FIG. 7.

As shown by operation 1406, the apparatus 300 may include means, such as processor 302, memory 304, communications hardware 306, smart mobile wallet circuitry 314, and/or the like for receiving a sender mDL validity response. The sender mDL validity response may be whether credential data (e.g., desired credential data) associated with the sender mDL indicated by the sender mDL authentication request was verified by the IA system. In some embodiments, operation 1406 may be performed in a substantially similar manner as described above with respect to operation 708 of FIG. 7.

As shown by operation 1408, the apparatus 300 may include means, such as processor 302, memory 304, authentication circuitry 310, smart mobile wallet circuitry 314, and/or the like for authenticating the sender based on the sender mDL validity response. The authentication circuitry 310 may be configured to authenticate the sender based on the data comprised in the sender mDL validity response received from the IA system. In some embodiments, operation 1408 may be performed in a substantially similar manner as described above with respect to operation 710 of FIG. 7.

In some embodiments, operation 1304 may additionally, or alternatively, be performed in accordance with the operations described by FIG. 15. Turning now to FIG. 15, example operations are shown for authenticating a sender based on user feedback.

As shown by operation 1502, the apparatus 300 may include means, such as processor 302, memory 304, communications hardware 306, user interface circuitry 312, smart mobile wallet circuitry 314, and/or the like for causing display of an indication of sender information. In some embodiments, sender information may include information associated with the sender mDL. For example, sender information may include sender identification data, desired credential data, or user attribute data. The sender information may be obtained from the sender mDL authentication request. The user interface circuitry 312 may then cause display of the sender information such that the recipient may view this sender information. The user interface circuitry 312 may display the sender information within the software application.

As shown by operation 1504, the apparatus 300 may include means, such as processor 302, memory 304, communications hardware 306, user interface circuitry 312, and/or the like for receiving user feedback indicative of whether to authenticate the sender. The communications hardware 306 may then receive user feedback indicative of whether to authenticate the sender based on the displayed sender information. For example, the recipient may view the displayed sender information to determine whether the displayed sender information matches the description, image, or known attributes of the nearby individual and/or an expected sender. Thus, the recipient may interact with apparatus 300 to provide user feedback indicative of whether to authenticate the sender. For example, within the software application, the recipient may be able to select an option of “authenticate” or “do not authenticate” to provide user feedback. If the recipient selects the “authenticate” option, the recipient may provide user feedback indicative to authenticate the sender. However, if the recipient selects the “do not authenticate” option, the recipient may provide user feedback indicative to not authenticate the sender.

As shown by operation 1506, the apparatus 300 may include means, such as processor 302, memory 304, authentication circuitry 310, and/or the like, for authenticating the sender based on the user feedback. Authentication circuitry 310 may determine whether the user feedback is indicative to authenticate the sender. In an instance in which the user feedback is indicative to authenticate the sender, the authentication circuitry 310 may successfully authenticate the sender. In an instance in which the user feedback fails to be indicative to authenticate the sender, the authentication circuitry 310 may fail to successfully authenticate the sender.

Returning now to FIG. 13, as shown by operation 1306, the apparatus 300 may include means, such as processor 302, memory 304, communications hardware 306, and/or the like for providing an authorization selection. Once authentication circuitry 310 has authenticated the sender, the communications hardware 306 may provide an authorization selection to the asset transfer management system 102. The authorization selection may be indicative of whether the recipient has successfully authenticated the sender based on the sender mDL. In some embodiments, the authorization selection may further be indicative of the manner in which the recipient authenticated the sender.

As shown by operation 1308, the apparatus 300 may include means, such as processor 302, memory 304, communications hardware 306, and/or the like for receiving an asset transfer notification. As described above in FIG. 4, the transfer notification may provide confirmation that the parties were both successfully authenticated and/or that transfer of the asset has occurred. The transfer notification may be received as a notification, email, text message, direct application message (e.g., via a software application), audio message (e.g., automated voice message), banner notification, and/or the like. In some embodiments, user interface circuitry 312 may be configured to display the transfer notification on an associated display. As such, the recipient may be informed that the asset transfer was successful.

FIGS. 4-15 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

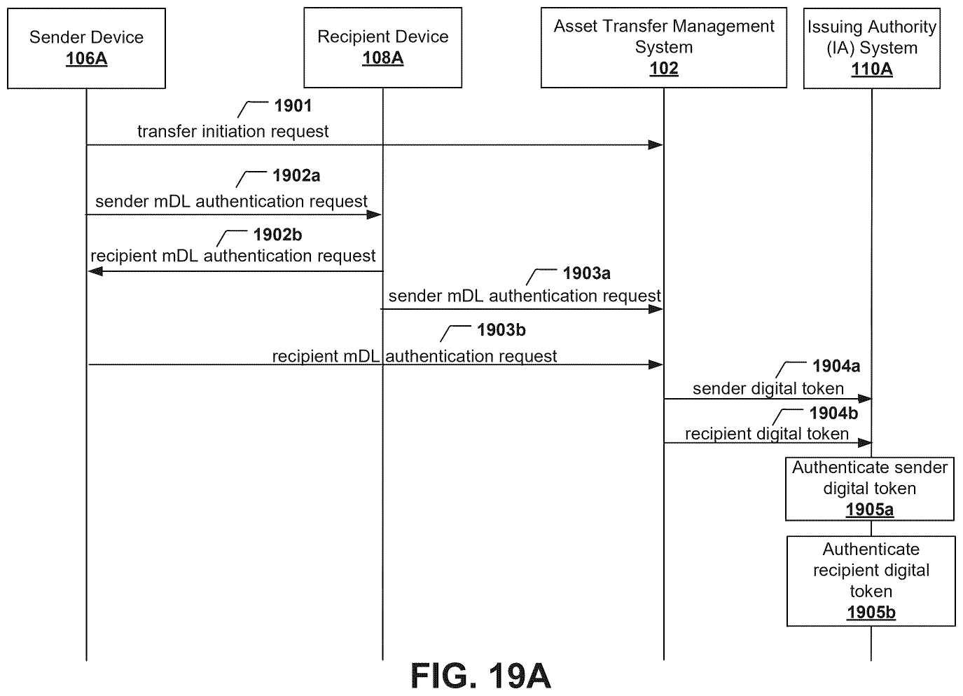

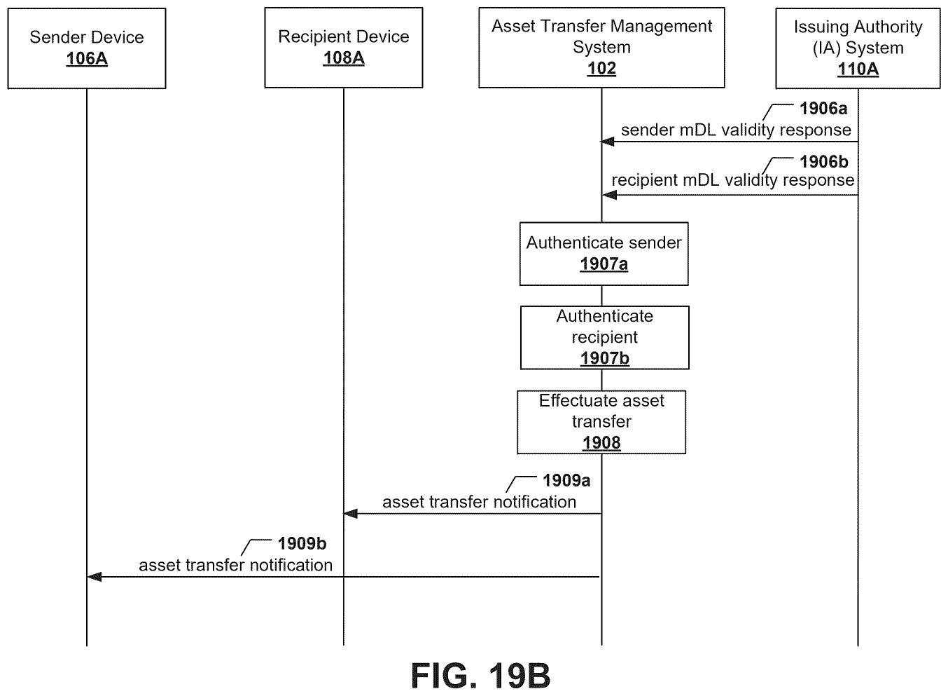

FIGS. 19A-19B, 20A-20B, and 21A-21B show swim lane diagrams illustrating example operations (e.g., as described above in connection with FIGS. 4-15) performed by components of the environment depicted in FIG. 1 to produce various benefits of the implementations described herein. The operations shown in the swim lane diagram performed by a sender device 106A are shown along the line extending from the box labeled “Sender Device 106A,” operations performed by a recipient device 108A are shown along the line extending from the box labeled “Recipient Device 108A,” operations performed by asset transfer management system 102 are shown along the line extending from the box labeled “Asset Transfer Management System 102,” and operations performed by IA system 110A are shown along the line extending from the box labeled “Issuing Authority (IA) System 110A.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIGS. 19A-19B, 20A-20B, and 21A-21B.

Turning first to FIGS. 19A-19B, example operations are shown for an embodiment where the asset transfer management system 102 performs the authentication for the sender device 106A and recipient device 108A. As shown in FIG. 19A, at operation 1901, the sender device 106A may provide a transfer initiation request to the asset transfer management system 102. At operation 1902a and 1902b, the sender device 106A may provide the recipient device 108A with the sender mDL authentication request and the recipient device 108A may provide the sender device 106A with the recipient mDL authentication request, respectively. At operation 1903a, the recipient device 108A may provide the asset transfer management system 102 with the sender mDL authentication request. At operation 1903b, the sender device 106A may provide the asset transfer management system 102 with the recipient mDL authentication request. At operation 1904a, the asset transfer management system 102 may provide an IA system 110A with the sender digital token. At operation 1904b, the asset transfer management system 102 may provide an IA system 110A with the recipient digital token. At operation 1905a, the IA system 110A may authenticate the sender digital token. At operation 1905b, the IA system 110A may authenticate the recipient digital token.

Turning now to FIG. 19B, at operation 1906a and 1906b, the IA system 110A may provide a sender mDL validity response and a recipient mDL validity response to the asset transfer management system 102, respectively. At operation 1907a, the asset transfer management system 102 may authenticate the sender based on the sender mDL validity response. At operation 1907b, the asset transfer management system 102 may authenticate the recipient based on the recipient mDL validity response. At operation 1908, the asset transfer management system 102 may effectuate the asset transfer in an instance in which both the sender and the recipient were successfully authenticated. At operation 1909a, the asset transfer management system 102 may provide an asset transfer notification to the recipient device 108A. At operation and 1909b, the asset transfer management system 102 may provide an asset transfer notification the sender device 106A.

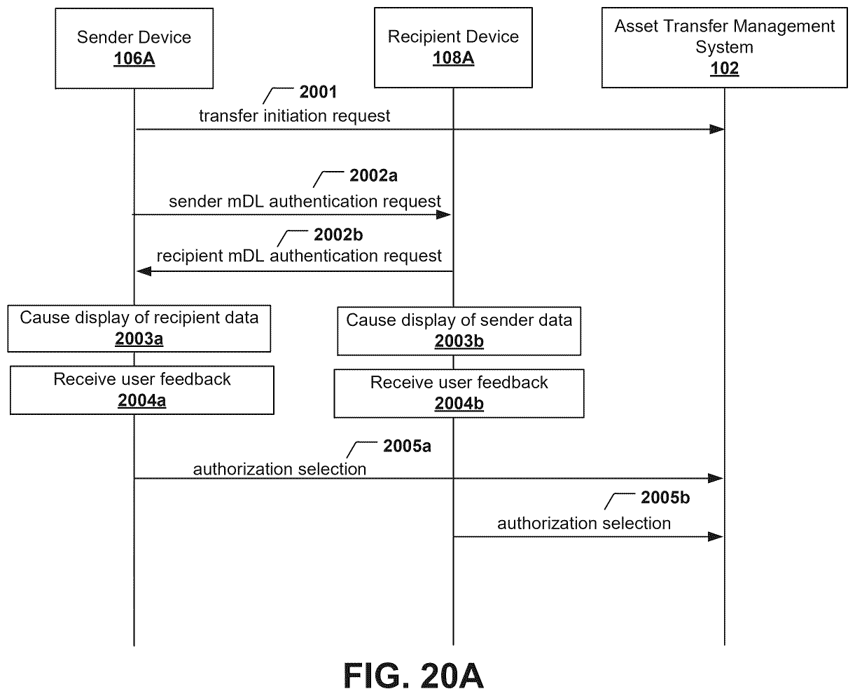

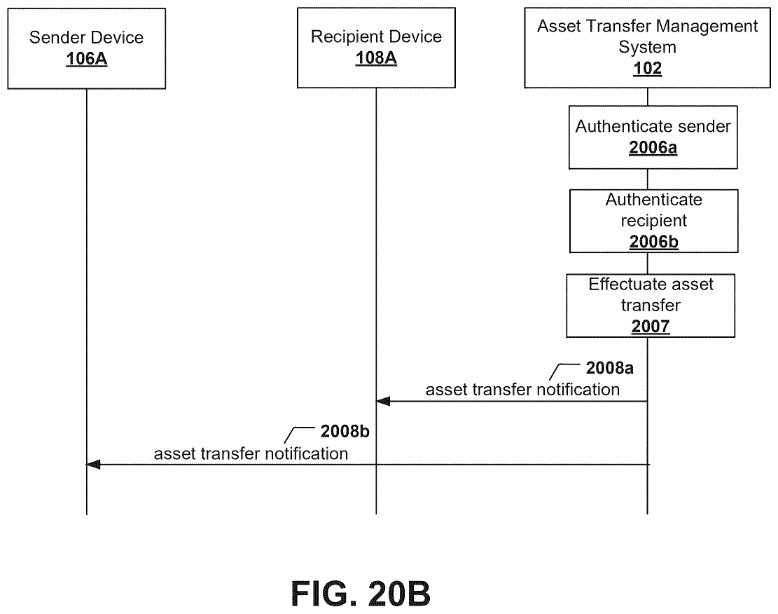

Turning next to FIGS. 20A-20B, example operations are shown for an embodiment where the sender device 106A performs the authentication for the recipient device 108A based on user feedback and the recipient device 108A performs the authentication for the sender device 106A based on user feedback. As shown in FIG. 20A, at operation 2001, the sender device 106A may provide a transfer initiation request to the asset transfer management system 102. At operation 2002a and 2002b, the sender device 106A may provide the recipient device 108A with the sender mDL authentication request and the recipient device 108A may provide the sender device 106A with the recipient mDL authentication request, respectively. At operation 2003a, the sender device 106A may cause display of recipient data. At operation 2003b, the recipient device 108A may cause display of sender data. At operation 2004a, the sender device 106A may receive user feedback indicative of whether to authenticate the recipient. At operation 2004b, the recipient device 108A may receive user feedback indicative of whether to authenticate the sender. At operation 2005a the sender device 106A may provide an authorization selection to the asset transfer management system 102. At operation 2005b the recipient device 108A may provide an authorization selection to the asset transfer management system 102.

Turning now to FIG. 20B, at operation 2006a, the asset transfer management system 102 may authenticate the sender based on the authorization selection received from the recipient device 108A. At operation 2006b, the asset transfer management system 102 may authenticate the recipient based on the authorization selection received from the sender device 106A. At operation 2007, the asset transfer management system 102 may effectuate the asset transfer in an instance in which both the sender and the recipient were successfully authenticated. At operation 2008a, the asset transfer management system 102 may provide an asset transfer notification to the recipient device 108A. At operation 2008b, the asset transfer management system 102 may provide an asset transfer notification the sender device 106A.

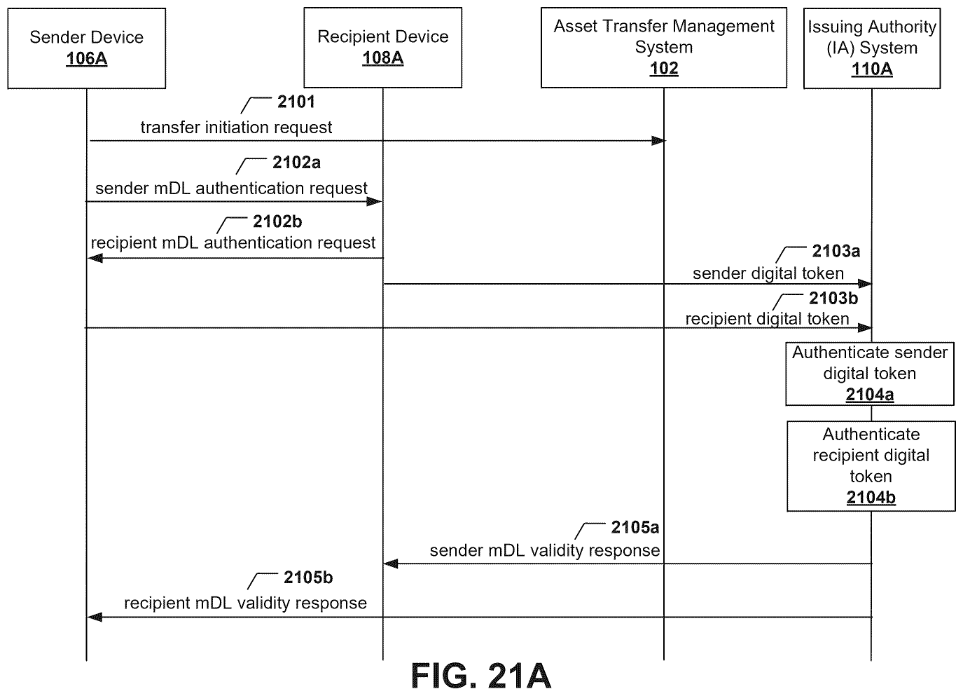

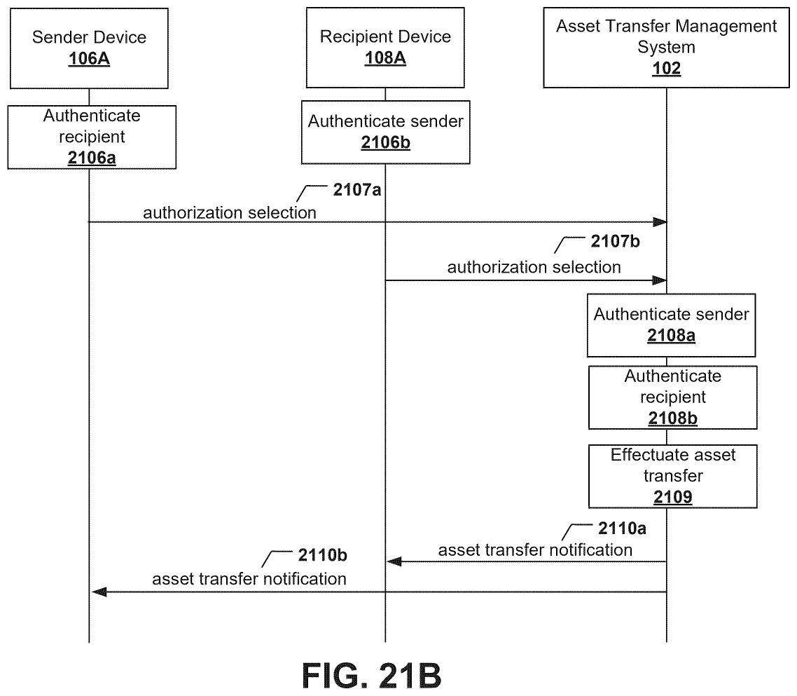

Finally, turning to FIGS. 21A-21B, example operations are shown for an embodiment where the sender device 106A performs the authentication for the recipient device 108A and the recipient device 108A performs the authentication for the sender device 106A. As shown in FIG. 21A, at operation 2101, the sender device 106A may provide a transfer initiation request to the asset transfer management system 102. At operation 2102a and 2102b, the sender device 106A may provide the recipient device 108A with the sender mDL authentication request and the recipient device 108A may provide the sender device 106A with the recipient mDL authentication request, respectively. At operation 2103a, the recipient device 108A may provide the IA system 110A with a sender digital token. At operation 2103b, the sender device 106A may provide the IA system 110A with a recipient digital token. At operation 2104a, the IA system 110A may authenticate the sender digital token. At operation 2104b, the IA system 110A may authenticate the recipient digital token. At operation 2105a, the IA system 110A may provide a sender mDL validity response to the recipient device 108A. At operation 2105b, the IA system 110A may provide a recipient mDL validity response to the sender device 106A.

Turning now to FIG. 21B, at operation 2106a, the sender device 106A may authenticate the recipient based on the recipient mDL validity response. At operation 2106b, the recipient device 108A may authenticate the sender based on the sender mDL validity response. At operation 2107a, the sender device 106A may provide the authorization selection to the asset transfer management system 102. At operation 2107b, the recipient device 108A may provide the authorization selection to the asset transfer management system 102. At operation 2108a, the asset transfer management system 102 may authenticate the sender based on the authorization selection received from the recipient device 108A. At operation 2108b, the asset transfer management system 102 may authenticate the recipient based on the authorization selection received from the sender device 106A. At operation 2109, the asset transfer management system 102 may effectuate the asset transfer in an instance in which both the sender and the recipient were successfully authenticated. At operation 2110a, the asset transfer management system 102 may provide an asset transfer notification to the recipient device 108A. At operation 2110b, the asset transfer management system 102 may provide an asset transfer notification the sender device 106A.

In some embodiments, some of the operations described above in connection with FIGS. 4-15 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable enhanced P2P transfers. Example embodiments thus provide tools that overcome the problems faced by conventional P2P transfer mechanisms and techniques. By avoiding the use of conventional asset transfer mechanisms and techniques, example embodiments thus save time and resources, while also reducing the likelihood of inadvertent or accidental asset transfer to an unintended recipient. Moreover, embodiments described herein counter a wide variety of emerging risks in an evolving technological landscape.

Example embodiments contemplated herein provide technical solutions that solve real-world problems faced by users who wish to safely and securely perform P2P transfers of assets by employing various mDL-based user authentication techniques. And while confirming the identity of an individual has been a technical challenge for years, the increasing number of self-employed individuals using online-based marketing tools, online classifieds, and/or service aggregation websites has made this problem significantly more acute, especially as identity fraud and impersonation techniques become more sophisticated. By utilizing a legally issued mDL to authenticate a sender and/or recipient, embodiments of the present disclosure ensure that both the sender and recipient are properly verified before performing the asset transfer, thereby increasing the security and safety of assets involved in the asset transfer.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for secure peer-to-peer asset transfer, the method comprising:
receiving, by communications hardware, an asset transfer initiation request from a sender device, wherein the asset transfer initiation request comprises an indication of an asset to transfer and a sender account identifier associated with a sender account of a sender;
receiving, by the communications hardware, an indication of a recipient intended to receive the asset;
selecting, by transfer management circuitry, a recipient account associated with the recipient;
authenticating, by authentication circuitry, the recipient based on a recipient mobile driver's license (mDL) associated with the recipient; and
in response to successfully authenticating the recipient, effectuating, by the transfer management circuitry, a transfer of the asset from the sender account to the recipient account.

2. The method of claim 1, wherein authenticating the recipient further comprises:
receiving, by the communications hardware, a recipient mDL authentication request from the sender device, wherein the recipient mDL authentication request is a request to authenticate the recipient mDL associated with the recipient;
generating, by the authentication circuitry and based on the recipient mDL authentication request, a recipient digital token;
transmitting, by the communications hardware, the recipient digital token to an issuing authority (IA) system associated with an IA that provisioned the recipient mDL to the recipient;
receiving, by the communications hardware and from the IA system, a recipient mDL validity response, wherein the recipient mDL validity response is generated based on the recipient digital token, and wherein the recipient mDL validity response indicates verified credential data associated with the recipient mDL; and
authenticating, by the authentication circuitry, the recipient based on the recipient mDL validity response.

3. The method of claim 2, wherein the recipient mDL authentication request comprises one or more of recipient identification data, desired credential data associated with the recipient mDL, or user attribute data associated with the recipient.

4. The method of claim 3, wherein the recipient mDL validity response further indicates verified recipient device identification data related to a recipient device.

5. The method of claim 1, wherein authenticating the recipient further comprises:
receiving, by the communications hardware, an authorization selection from the sender device, wherein the authorization selection is indicative of whether the sender authenticated the recipient based on the recipient mDL; and
authenticating, by the authentication circuitry, the recipient in an instance in which the authorization selection is indicative that the sender successfully authenticated the recipient.

6. The method of claim 1, further comprising:
receiving, by the communications hardware, a candidate recipient identification request from the sender device, wherein the candidate recipient identification request comprises a location of the sender device;
identifying, by the transfer management circuitry, one or more candidate recipient identifiers, wherein each candidate recipient identifier is associated with a candidate recipient device located within a predefined proximity of the location of the sender device; and
providing, by the communications hardware, the one or more candidate recipient identifiers to the sender device.

7. The method of claim 1, further comprising:
authenticating, by the authentication circuitry, the sender based on a sender mDL associated with the sender, wherein the transfer of the asset to the recipient is effectuated in response to successfully authenticating the recipient and successfully authenticating the sender.

8. The method of claim 7, wherein authenticating the sender further comprises:
receiving, by the communications hardware, a sender mDL authentication request from a recipient device, wherein the sender mDL authentication request is a request to authenticate the sender mDL associated with the sender;
generating, by the authentication circuitry and based on the sender mDL authentication request, a digital token;
transmitting, by the communications hardware, the digital token to an issuing authority (IA) system associated with an IA that provisioned the sender mDL to the sender;
receiving, by the communications hardware and from the IA system, a sender mDL validity response, wherein the sender mDL validity response is generated based on the digital token, and wherein the sender mDL validity response indicates verified credential data associated with the sender mDL; and
authenticating, by the authentication circuitry, the sender based on the sender mDL validity response.

9. The method of claim 8, wherein the sender mDL authentication request comprises one or more of sender identification data, desired credential data associated with the sender mDL, or user attribute data associated with the sender.

10. The method of claim 9, wherein the sender mDL validity response further indicates verified sender device identification data related to the sender device.

11. The method of claim 7, wherein authenticating the sender further comprises:
receiving, by the communications hardware, an authorization selection from a recipient device, wherein the authorization selection is indicative of whether the recipient has authenticated the sender based on the sender mDL; and
authenticating, by the authentication circuitry, the sender in an instance in which the authorization selection is indicative that the recipient successfully authenticated the sender.

12. An apparatus for secure peer-to-peer asset transfer, the apparatus comprising:
communications hardware configured to:
receive an asset transfer initiation request from a sender device, wherein the asset transfer initiation request comprises an indication of an asset to transfer and a sender account identifier associated with a sender account of a sender, and
receive an indication of a recipient intended to receive the asset;
transfer management circuitry configured to select a recipient account associated with the recipient; and
authentication circuitry configured to authenticate the recipient based on a recipient mobile driver's license (mDL) associated with the recipient;
wherein the transfer management circuitry is further configured to, in response to successfully authenticating the recipient, effectuate a transfer of the asset from the sender account to the recipient account.

13. The apparatus of claim 12, wherein the communications hardware is further configured to receive a recipient mDL authentication request from the sender device, wherein the recipient mDL authentication request is a request to authenticate a recipient mDL associated with the recipient;
wherein the authentication circuitry is further configured to generate, based on the recipient mDL authentication request, a recipient digital token;
wherein the communications hardware is further configured to:
transmit the recipient digital token to an issuing authority (IA) system associated with an IA that provisioned the recipient mDL to the recipient, and
receive, from the IA system, a recipient mDL validity response, wherein the recipient mDL validity response is generated based on the recipient digital token, and wherein the recipient mDL validity response indicates verified credential data associated with the recipient mDL; and
wherein the authentication circuitry is further configured to authenticate the recipient based on the recipient mDL validity response.

14. The apparatus of claim 13, wherein the recipient mDL authentication request comprises one or more of recipient identification data, desired credential data associated with the recipient mDL, or user attribute data associated with the recipient.

15. The apparatus of claim 14, wherein the recipient mDL validity response further indicates verified recipient device identification data related to a recipient device.

16. The apparatus of claim 12, wherein the communications hardware is further configured to receive an authorization selection from the sender device, wherein the authorization selection is indicative of whether the sender authenticated the recipient based on the recipient mDL; and
wherein the authentication circuitry is further configured to authenticate the recipient in an instance in which the authorization selection is indicative that the sender successfully authenticated the recipient.

17. The apparatus of claim 12, wherein the communications hardware is further configured to receive a candidate recipient identification request from the sender device, wherein the candidate recipient identification request comprises a location of the sender device;
wherein the transfer management circuitry is further configured to identify one or more candidate recipient identifiers, wherein each candidate recipient identifier is associated with a candidate recipient device located within a predefined proximity of the location of the sender device; and
wherein the communications hardware is further configured to provide the one or more candidate recipient identifiers to the sender device.

18. The apparatus of claim 12, wherein the authentication circuitry is further configured to authenticate the sender based on a sender mDL associated with the sender, wherein the transfer of the asset to the recipient is effectuated in response to successfully authenticating the recipient and successfully authenticating the sender.

19. The apparatus of claim 18, wherein the communications hardware is further configured to receive a sender mDL authentication request from a recipient device, wherein the sender mDL authentication request is a request to authenticate a sender mDL associated with the sender;
wherein the authentication circuitry is further configured to generate, based on the sender mDL authentication request, a sender digital token;
wherein the communications hardware is further configured to:
transmit the sender digital token to an issuing authority (IA) system associated with an IA that provisioned the sender mDL to the sender, and
receive, from the IA system, a sender mDL validity response, wherein the sender mDL validity response is generated based on the sender digital token, and wherein the sender mDL validity response indicates verified credential data associated with the sender mDL; and
wherein the authentication circuitry is further configured to authenticate the sender based on the sender mDL validity response.

20. A system for secure peer-to-peer asset transfer, the system comprising:
means for receiving an asset transfer initiation request from a sender device, wherein the asset transfer initiation request comprises an indication of an asset to transfer and a sender account identifier associated with a sender account of a sender;
means for receiving an indication of a recipient intended to receive the asset;
means for selecting a recipient account associated with the recipient;
means for authenticating the recipient based on a recipient mobile driver's license (mDL) associated with the recipient; and
means for, in response to successfully authenticating the recipient, effectuating a transfer of the asset from the sender account to the recipient account.
